(19) United States
(12) Patent Application Publication
(10) Pub. No.: US 2017/0362048 A1
(43) Pub. Date: Dec. 21, 2017

(54) APPARATUS FOR PROCESSING SHEETS AND APPARATUS FOR FORMING IMAGES PROVIDED WITH THE APPARATUS

(71) Applicant: Misao KOBAYASHI, Kofu-shi (JP)

(72) Inventor: Misao KOBAYASHI, Kofu-shi (JP)

(73) Assignee: NISCA CORPORATION, Minamikoma-gun (JP)

(21) Appl. No.: 15/620,342

(22) Filed: Jun. 12, 2017

(30) Foreign Application Priority Data
Jun. 15, 2016 (JP) 2016-118492
Jun. 15, 2016 (JP) 2016-118641
Jun. 15, 2016 (JP) 2016-118642
Jun. 29, 2016 (JP) 2016-128331

(51) Int. Cl. B65H 37/04; B31F 5/02; B42B 2/02

(52) U.S. Cl. CPC B65H 37/04; B42B 2/02; B31F 5/02; B65H 2801/27

(57) ABSTRACT

The present apparatus includes a placement tray to place sheets to undergo binding processing, and a press bind unit shifting along an end edge of sheets on the placement tray. The press bind unit includes a receiving tooth, and pressing teeth meshing with the receiving tooth to perform press binding on sheets nipped therebetween, and the pressing teeth are provided to shift between a press position for meshing with the receiving tooth, and a retract position spaced apart from the receiving tooth so as to shift the press bind unit along the end edge of sheets with the sheets disposed between the receiving tooth and the pressing teeth. By shifting the pressing teeth to the retract position, it is possible to shift the sheet bind apparatus smoothly along the end edge of a bunch of sheets with the sheets disposed between the receiving tooth and the pressing teeth.

### BACKGROUND OF THE INVENTION

### 1. Field of the Invention

The present invention relates to a sheet processing apparatus for performing binding processing on sheets in the shape of a bunch, and more specifically, to a sheet processing apparatus which performs press binding processing for pressing a bunch of sheets to bind, and further preferably, which is capable of also performing needle binding processing for binding a bunch of sheets using a needle, and an image formation apparatus provided with the sheet processing apparatus.

### 2. Description of the Related Art

Conventionally, in image formation apparatuses such as a copier, laser beam printer, facsimile and complex apparatus thereof, there have been apparatuses provided with sheet processing apparatuses for performing various types of sheet processing such as binding processing on sheets with images formed. In such an image formation apparatus, in the case of binding a bunch of sheets with the sheet processing apparatus, it is general to bind a bunch of sheets using a staple made of metal.

However, in peeling a bunch of sheets subjected to binding processing using a staple, since it is necessary to remove the staple, work is not only burdensome, but also the sheet is easy to be broken. Therefore, a needleless binding mechanism is also known where a bunch of sheets is pressed with a press mechanism to mutually deform the sheets, and is bound, and it is possible to easily peel a bunch of thus press-bound sheets.

In Japanese Patent Application Publication No. 2016-10968 is disclosed a press bind mechanism where upper teeth and lower teeth are obliquely attached to a rotating shaft of an arm for supporting teeth, and gradually mesh with one another. According to this mechanism, since a bunch of sheets is gradually deformed along the rotation center of a support portion and is bound, in nipping sheets to start meshing, as shown in FIG. 13(a) of the Publication No. 2016-10968, pressing is started from a beginning side, and it is thereby possible to reduce a maximum load required for press binding.

In Japanese Patent Application Publication No. 2015-9956, with respect to a needleless unit (needleless bind means) fixed to the rear side of an apparatus, in shifting a bunch of sheet to guide to the needleless unit, a tray inclined guide and upper teeth inclined guide are respectively provided to guide a bunch of sheets to between upper teeth and lower teeth. In this needleless binding, as shown in FIGS. 13 and 14 of the Publication No. 2015-9956, since the needleless unit is fixed and the number of binding sheets is low, it is possible to nip sheets relatively smoothly.

Further, a sheet processing apparatus is known which is equipped with a needle bind unit and press bind unit as a single bind apparatus so as to perform needle binding on a bunch of sheets in the case where the number of sheets to bind is high (for example, about 11 to 50) and to perform press binding in the case where the number is low (for example, about several).

For example, in an image formation apparatus of Japanese Patent Application Publication No. 2012-27118, a press bind unit with a relatively wide width and a needle bind unit (stapler) with a width narrower than the wide width are provided together, and are shifted integrally along a sheet end edge. Further, in a sheet processing apparatus of Japanese Patent Application Publication No. 2015-30584, a press binding member is provided so as to cover a needle binding member that rotates, and is configured to rotate about another shaft different from that of the needle binding member as the center, and the same drive motor is switched to perform press binding or needle binding.

### SUMMARY OF THE INVENTION

Generally, the needle bind unit is provided with an opening portion with a wide opening so as to bind the relatively high number of sheets as described above, and it is possible to shift the apparatus to a desired bind position along the end edge of sheets with the sheets placed in the opening portion. On the other hand, in the press bind unit, since the number of sheets capable of being bound at a time is low, a relatively narrow distance between the teeth is enough in receiving sheets. Conversely, when the distance between the teeth is too large, there is the risk that flutters of the sheet front end portion occur on the contrary.

Therefore, herein, it is a first object to provide an apparatus provided with a press bind unit capable of shifting in a width direction along an end edge of sheets with the sheets to undergo binding processing placed.

In order to attain the above-mentioned first object, it is disclosed herein that an apparatus is provided with a placement tray to place sheets to undergo binding processing, and a press bind unit capable of shifting along an end edge of sheets on the placement tray, the press bind unit includes a receiving tooth, and a pressing tooth which meshes with the receiving tooth to perform press binding on the sheets nipped therebetween, and that the pressing tooth is provided to be able to shift between a press position for meshing with the receiving tooth, and a retract position spaced apart from the receiving tooth so as to shift the press bind unit along the end edge of sheets with the sheets disposed between the receiving tooth and the pressing tooth.

Further, it is a second object to provide an apparatus which shifts a sheet guide for guiding a sheet in conjunction with a pressing tooth up-and-down shift also in carrying the sheet in a press bind unit for binding a bunch of sheets with the pressing tooth, and which is capable of stably carrying the sheet in a press position without requiring particular drive for a shift of the sheet guide.

In order to attain the above-mentioned second object, it is disclosed that the press bind unit is provided with a receiving portion including an opening to receive a part of a bunch of placed sheets, pressing teeth that press from the frontside and backside of a bunch of sheets received in the receiving portion in a bind position to crimp the sheets, and a sheet guide provided in the receiving portion to guide a sheet to carry in to the bind position, and that the sheet guide is held to shift between a guide position for narrowing the opening to carry the sheet in the bind position and an expanded position with an opening wider than the opening, in conjunction with a shift in a pressing direction of the pressing teeth.

In addition, it is a third object to provide an apparatus for expanding a bind opening at the time of shifting when the bind unit for shifting along a sheet edge shifts along a sheet end edge, and thereby reducing the occurrence of a jam caused by catching a sheet due to a unit shift.

In order to attain the above-mentioned third object, it is disclosed herein that a sheet processing apparatus is comprised of a bind unit that shifts along an end edge of a bunch of sheets placed on a placement tray, the bind unit is provided with a receiving portion including an opening to receive a part of a bunch of placed sheets, a bind portion that binds the bunch of sheets received in the receiving portion in a bind position, and a sheet guide provided in the receiving portion to guide a bunch of sheets to carry in to the bind position, and that the sheet guide is able to be positioned in a guide position for narrowing the opening to carry in the sheets and in an expanded position with an opening wider than the opening, and when the bind unit shifts along the end edge of a bunch of sheets, is positioned in the expanded position.

Further, it is a fourth object to provide an apparatus for shortening a separation distance between a pressing tooth and a receiving tooth to enable processing time of press binding to be reduced, in the case of performing sheet carry-in in a press bind position smoothly, while performing press binding in a different position of the same bunch of sheets once subjected to press binding.

In order to attain the above-mentioned fourth object, it is disclosed herein that a press bind unit is able to shift along an end edge of a bunch of sheets on a placement tray, and is provided with a receiving tooth, and a pressing tooth which meshes with the receiving tooth to perform press binding on the bunch of sheets nipped therebetween, and that the pressing tooth includes a press position for meshing with the receiving tooth, and a sheet receiving position spaced a predetermined distance away from the receiving tooth to receive the sheets in between the receiving tooth and the pressing tooth, and in the case of displacing the press position after pressing the bunch of sheets to perform multiple press binding, is shifted to an intermediate position between the press position and the sheet receiving position.

### BRIEF DESCRIPTION OF THE DRAWINGS

FIG. 1 is an entire configuration view of an image formation system provided with a sheet processing apparatus in an Embodiment of the present invention;

FIG. 2 is an enlarged view illustrating the sheet processing apparatus of FIG. 1;

FIG. 3 is a plan view schematically illustrating an arrangement on a processing tray of a sheet bind apparatus with a needle bind unit and press bind unit integrated;

FIG. 4 is a perspective view illustrating a position relationship between the needle bind unit and the press bind unit provided together;

FIG. 5A is a plan view schematically illustrating a configuration of the press bind unit; FIG. 5B is a partial sectional side elevational view; FIG. 5C is a bottom view;

FIG. 6A is a perspective view illustrating a drive system of the press bind unit; FIG. 6B is an exploded perspective view illustrating a cylindrical cam and components related thereto;

FIG. 7 is a perspective view of a base plate without the drive system;

FIG. 8 is an exploded perspective view of pressing plates respectively on the rear side, center and front side disposed between a front plate and the base plate;

FIG. 9 is a perspective view illustrating a position relationship between the front plate and the base plate;

FIG. 10 is an explanatory view of a press position in which a pressing tooth is pressed against a receiving tooth;

FIG. 11 is an explanatory view of a sheet receiving position in which the pressing tooth separates upward from the receiving tooth;

FIG. 12A is a developed view of a cam groove of the cylindrical cam; FIGS. 12B to 12E are explanatory views illustrating shifts of the pressing plates in association with rotation of the cylindrical cam;

FIG. 13A is a partial developed view illustrating a region S5 of the cam groove of the cylindrical cam; FIGS. 13B to 13F are explanatory views illustrating shifts and pressing operation of the pressing plates in associated with rotation of the cylindrical cam continued from FIG. 12E;

FIG. 14 is an explanatory view illustrating a position of the press bind unit in the case of performing press binding on sheets;

FIG. 15 is an explanatory view illustrating a position of the needle bind unit in the case of performing needle binding on a bunch of shifted sheets on the rear side;

FIG. 16A is a perspective view illustrating an attachment state of a sheet guide; FIG. 16B is an explanatory view illustrating a position relationship between the sheet guide and the pressing plates;

FIG. 17A is a cross-sectional explanatory view where the pressing tooth and sheet guide are in retract positions separated farthest from the receiving tooth, FIG. 17B is a cross-sectional explanatory view where the pressing tooth and sheet guide are in receiving positions for receiving sheets, FIG. 17C is a front explanatory view of FIG. 17A, and FIG. 17D is a front explanatory view of FIG. 17B;

FIG. 18A is a cross-sectional explanatory view where the pressing tooth is in a press position for crimping a bunch of sheets, FIG. 18B is a cross-sectional view where the pressing tooth is in an intermediate position between the sheet receiving position and the press position for performing crimping again after crimping with the pressing tooth, FIG. 18C is a front explanatory view of FIG. 18A, and FIG. 18D is a front explanatory view of FIG. 18B;

FIG. 19A is a view where the press bind unit shifts to the front side to perform crimping again after crimping with the pressing tooth corresponding to FIG. 18B; FIG. 19B is a view illustrating press traces obtained by performing multiple press binding; FIG. 19C is a view illustrating a Modification of the press traces; and

FIGS. 20A and 20B are developed views respectively illustrating Modifications of the cam groove shown in FIG. 12A; and

FIG. 21 is a block diagram illustrating a control configuration of an image formation apparatus including the sheet processing apparatus of this Embodiment.

### DESCRIPTION OF THE EMBODIMENTS

Referring to accompanying drawings, preferred Embodiments of the present invention will be described below in detail. In addition, in the accompanying drawings, through the entire present Description, similar components are assigned the same reference numerals to represent.

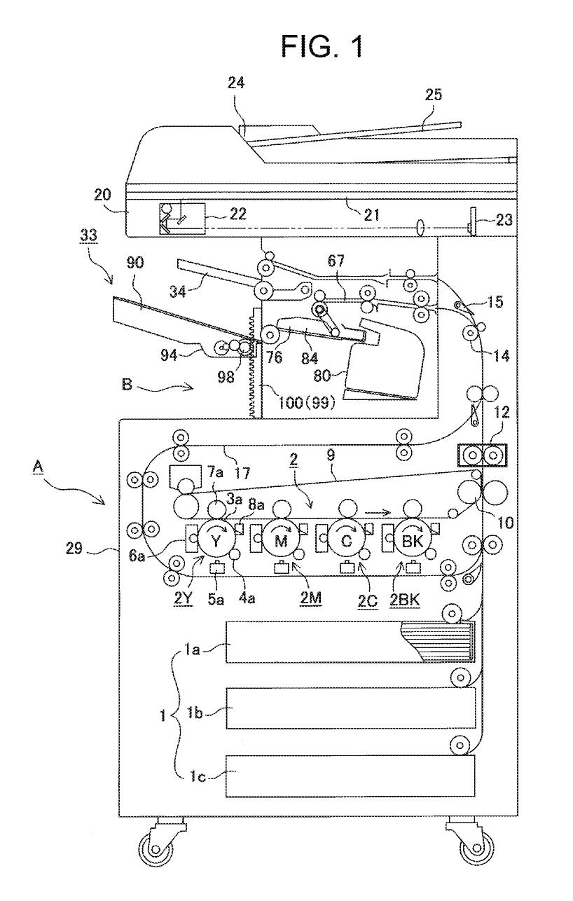

FIG. 1 schematically illustrates an entire configuration of an image formation system comprised of an image formation apparatus A and sheet processing apparatus B according to the present invention. The sheet processing apparatus B is to collate a plurality of sheets with images formed in the image formation apparatus A, and perform binding processing on a bunch of collected sheets ST. In addition, in the present Description, the front side of the image formation system of FIG. 1 i.e. the side facing a user of the image formation system is referred to as the front side, and the back side is referred to as the rear side.

### [Image Formation Apparatus A]

In the image formation apparatus A shown in FIG. 1 are disposed a paper feed section 1 comprised of three-stage paper feed cassettes 1a, 1b, 1c to store sheets below an image formation section 2 using an electrophotographic scheme, and when the sheet processing apparatus B is not inserted, with space above the image formation section 2 being sheet discharge space, an image reading apparatus 20 is disposed above the space. Accordingly, when the sheet processing apparatus B is disposed, the apparatus is the so-called in-body type using the sheet discharge space as shown in the figure.

The image formation section 2 adopts a tandem scheme using an intermediate transfer belt. In other words, color components of four colors (yellow 2Y, magenta 2M, cyan 2C and black 2BK) are used. For example, in yellow 2Y, the section 2 has a photoconductor drum 3a as an image support body, a charging apparatus 4a comprised of a charging roller that charges the photoconductor drum 3a, and an exposure apparatus 5a that makes an image signal read with the image reading apparatus 20 a latent image.

Further, the section 2 is provided with a development apparatus 6a that forms the latent image formed on the photoconductor drum 3a as a toner image, and a first transfer roller 7a that first-transfers the image on the photoconductor drum 3a formed by the development apparatus 6a to an intermediate transfer belt 9. By this configuration, the image is first-transferred to the intermediate transfer belt 9 for each color component. Then, the color component left on the photoconductor drum 3a is collected by a photoconductor cleaner 8a to prepare for next image formation. These schemes are the same as in the other color components.

In addition, the image of the intermediate transfer belt 9 is transferred to a sheet fed from the paper feed section 1 by a second-transfer roller 10, and the image is fused to the sheet by pressurized force and heat by a fusing apparatus 12. The remaining superimposed color components on the intermediate transfer belt 9 are removed by an intermediate belt cleaner to prepare for next transfer.

Thus image-formed sheet is discharged to the sheet processing apparatus B from a discharge roller 14. When image formation is performed on both sides of a sheet, the sheet once transported to the sheet processing apparatus B side with a switch gate 15 is switched back, transported to a circulation path 17, and is fed to the image formation section 2 again to form an image on the backside of the sheet. Then, the sheet with the image thus formed on one side or both sides is transported to the sheet processing apparatus B through the discharge roller 14.

The image reading apparatus 20 is disposed above the sheet discharge space above the image formation section 2. Herein, an original document placed on an original document stacker 25 is fed to platen 21 with an original document feeding apparatus 24, the fed original document is sequentially read with a photoelectric converter (for example, CCD) by irradiating using a scan unit 22, and the image is stored in a data storage section not shown. The stored image is formed on the sheet in the image formation section 2 as described above.

### [Sheet Processing Apparatus]

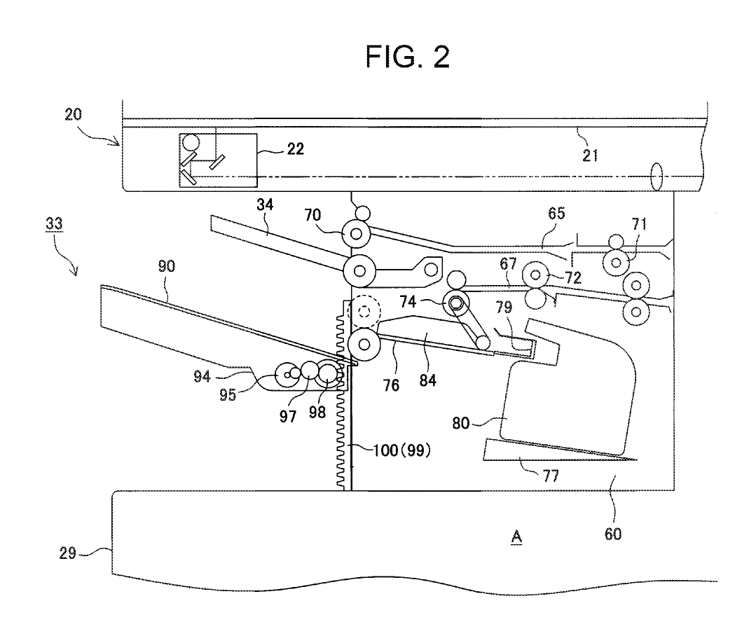

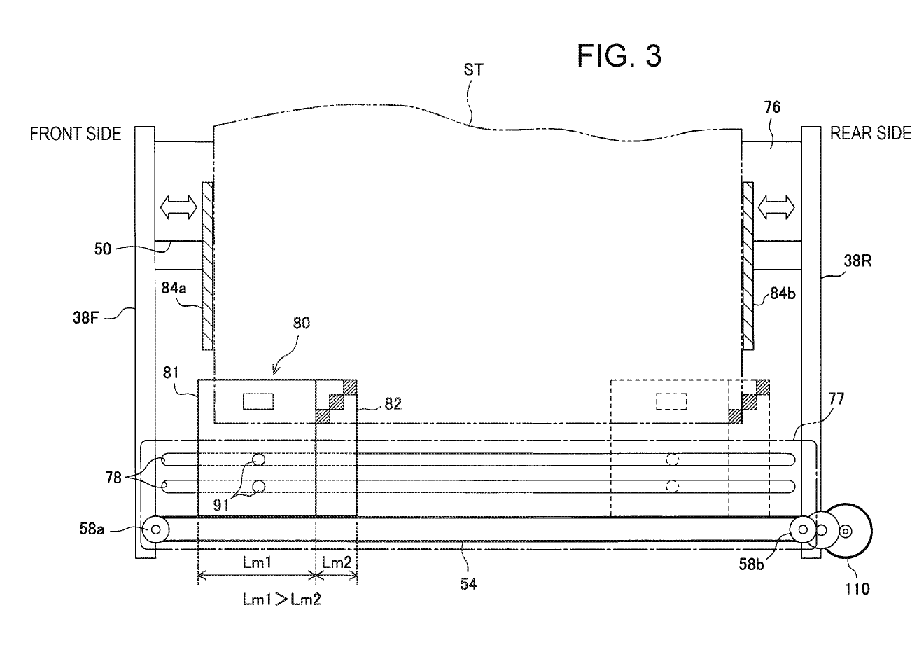

The sheet processing apparatus B is disposed in the sheet discharge space below the image reading apparatus 20, above the image formation section 2. Then, as shown in FIG. 2, the sheet processing apparatus B is comprised of a switchback path 65, a sheet discharge path 67 for transporting an image-formed sheet sequentially fed from the image formation section 2 to perform sheet binding, a processing tray 76 acting as a placement tray to which the sheet from the sheet discharge path 67 is temporarily introduced to place, a sheet bind unit 80 that binds a bunch of sheets ST (shown in FIG. 3) placed on the processing tray 76, and a tray unit 33 having a collection tray 90 which collects the bunch of sheets ST bound in the sheet bind unit 80 or discharged sheets without being bound and moves up and down. These apparatuses will be described below.

### [Switchback Path]

As shown in FIG. 2, in the switchback path 65, a transport roller 71 is disposed on the entrance side, a discharge roller 70 is disposed on the exit side, and when the image formation section 2 forms an image also on the backside of the sheet, the path functions as a path to switch back the sheet. Then, as necessary, a sheet such as a thick sheet which is not suitable for both sides and binding processing in a sheet bind apparatus 32 is discharged to an escape tray 34 positioned above the tray unit 33 with the discharge roller 70.

### [Tray Unit]

The tray unit 33 has the collection tray 90 which collects the bunch of sheets ST bound in the sheet bind unit 80 or discharged sheets without being bound and moves up and down. In the collection tray 90, an up-and-down pinion 98 of the collection tray 90 engages in an up-and-down rack 100 constituting apart of an up-and-down rail 99 that is a shift rail to rotate, and the tray thereby moves up and down. The up-and-down pinion 98 is driven by an up-and-down motor 95 disposed in an up-and-down motor installation portion 94 below the collection tray 90 via a transmission gear 97 and the like.

### [Sheet Discharge Path]

The sheet discharge path 67 is formed linearly approximately in the horizontal direction, a carry-in roller pair 72 is disposed on the entrance side to couple to a sheet carrying-out outlet of the image formation section 2, and a sheet discharge roller pair 74 is disposed on the exit side. Then, the roller pair is driven by a drive motor, not shown, to transport a sheet.

### [Processing Tray]

The processing tray 76 is provided as a placement tray to place sheets to undergo binding processing, and is provided with a regulation stopper 79 that regulates a position of the rear end portion in a sheet discharge direction (direction from the right to the left in FIG. 2) of the sheet. The sheet discharged from the sheet discharge path 67 is reversely transported in a direction (rightward in FIG. 2) opposite to the discharged direction by a transport means not shown, and is introduced to the processing tray 76. Thus fed sheet is regulated at its front end by the regulation stopper 79, and the front end position is aligned.

FIG. 3 shows a plan view of the processing tray 76, and the processing tray 76 is positioned in space that is partitioned and formed with a front-side frame 38F and rear-side frame 38R. The processing tray 76 is provided with an alignment apparatus 84 to position the sheet, which is introduced toward the sheet bind unit 80 from the upper direction in FIG. 2 by the reverse transport, in a direction orthogonal to the transport direction. The alignment apparatus 84 has a pair of alignment plates 84a, 84b that are respectively disposed on the front side and rear side of the processing tray 76 and that move back and forth in the direction orthogonal to the transport direction.

Each of the alignment plates 84a, 84b is provided as an alignment member for aligning the position of the sheet on the processing tray 76 in the shift direction of the sheet bind unit 80, engages in a guide groove 50 formed in the direction orthogonal to the sheet transport direction in a sheet support surface of the processing tray 76, slides in the guide groove 50, and is supported to be able to shift. It is possible to shift the alignment plates 84a, 84b individually with an alignment plate drive mechanism not shown. For example, each of the alignment plates 84a, 84b is held by a belt not shown looped between pulleys disposed on the front side and the rear side respectively, the belt is driven by a front-side alignment motor 112 or a rear-side alignment motor 113 respectively, and it is thereby possible to shift as described above.

### [Sheet Bind Apparatus]

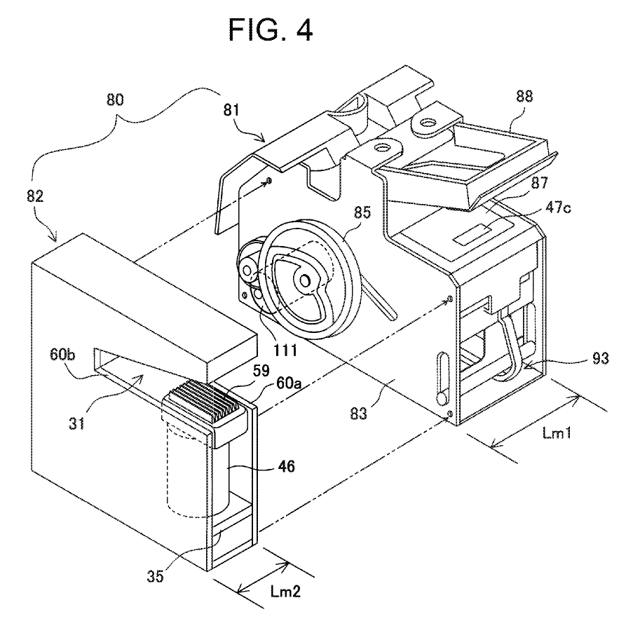

As shown in FIG. 4, the sheet bind unit 80 is configured integrally by arranging a needle bind unit 81 and press bind unit 82 parallel in the lateral direction. As shown in FIGS. 2 and 3, the sheet bind unit 80 is disposed on the front end side of the processing tray 76 i.e. near the end edge on the side opposite to the collection tray 90, where the front, which is the side to receive a sheet to undergo binding processing, of the needle bind unit 81 and press bind unit 82 faces the processing tray 76 side.

Below the front end-side end portion of the processing tray 76 is provided a shift bench 77 of the sheet bind unit 80 which extends over the entire width at least in the right-and-left direction (i.e. from the front side to the rear side). In the shift bench 77 is formed a pair of parallel grooves 78 extending over substantially the entire width in the right-and-left direction. The sheet bind unit 80 is installed on the shift bench 77 by respectively fitting a pair of protrusions 91 provided in its bottom portion into the grooves 78 slidably.

In the frames 38F, 38R are disposed a pair of left and right pulleys 58a, 58b, and a timing belt 54 (belt with teeth) is looped between the pulleys. To one of the pulleys 58b is coupled a bind unit shift motor 110. The sheet bind unit 80 is coupled to the timing belt 54, and by driving the bind unit shift motor 110, is capable of reciprocating and shifting in the right-and-left direction on the shift bench 77.

In this Embodiment, a breadth of the press bind unit 82 constituting the sheet bind unit 80 i.e. a dimension in its shift direction is set to be smaller than a breadth of the needle bind unit 81 constituting the sheet bind unit 80 similarly. In other words, in FIGS. 3 and 4, when it is assumed that the breadth of the press bind unit 82 is Lm2, and that the breadth of the needle bind unit 81 is Lm1, it is set that Lm2<Lm1. For example, when the breadth Lm1 of the needle bind unit 81 is about 60 mm, it is possible to set the breadth Lm2 of the press bind unit 82 at about 15 mm.

By this means, as the needle bind unit 81, also in adopting a general apparatus•mechanism that have conventionally been used as described later, it is possible to suppress the dimension not to be excess in the shift direction of the sheet bind unit 80 provided with the needle bind unit 81 and press bind apparatus 82 together, and to make the apparatus smaller than at least the same type of conventional sheet bind apparatus. By this means, it is possible to suppress upsizing of the sheet processing apparatus B itself, and to concurrently suppress manufacturing costs by using the conventional general needle bind unit.

### [Needle Bind Unit]

As the needle bind unit 81 are used various types conventionally known as the apparatus for performing binding processing with staples. For example, in the needle bind unit 81 shown in FIG. 4, a needle bind motor 111 is stored inside a unit frame 83 forming a contour of the unit, and on the side surface of the unit frame 83 is disposed a drive cam 85 that is driven to rotate by the needle bind motor 111.

In the lower portion of the unit frame 83 is provided a drive mechanism portion 93 that drives a staple formed in the shape of a C toward a bunch of sheets ST on the processing tray 76 to be driven by the drive cam 85. On the upper surface of the unit frame 83 is formed a table 87 to place a bind portion of the bunch of sheets ST on the processing tray 76. The drive mechanism portion 93 drives a staple upward from the lower surface side of the table 87 toward the bunch of sheets ST disposed on the table 87.

In the upper portion of the unit frame 83 is provided a clincher mechanism portion 88 that bends the staple legs, which are driven by the drive mechanism portion 93 and penetrate the top surface side of the bunch of sheets ST on the table 87, along the top surface of the bunch of sheets ST. In the clincher mechanism portion 88, a rear end portion is pivotally fitted into the unit frame 83, and the bunch of sheets ST disposed on the table 87 is nipped between the top surface of the table 87 and the clincher mechanism portion 88.

Further, in the clincher mechanism portion 88 is formed a cutter unit (not shown) that cuts front end portions of the staple legs which penetrate the bunch of sheets ST and protrude upward. By the cutter unit, the front end portions of the staple legs are cut to make lengths protruding from the bunch of sheets certain, and subsequently, the clincher mechanism portion 88 bends the staple legs along the top surface of the bunch of sheets ST to perform staple binding.

Between the table 87 and the clincher mechanism portion 88 is defined an opening portion of sufficient dimensions to place the number of sheets capable of undergoing needle binding with the needle bind unit 81. Accordingly, it is possible to shift the needle bind unit 81 smoothly in the right-and-left direction in a state in which a bunch of sheets ST to undergo binding processing or subjected to binding processing is placed on the table 87, without the bunch of sheets ST being caught or damaged.

### [Press Bind Unit]

The press bind unit 82 performs press binding for pressing a bunch of sheets ST from both the frontside and the backside between press teeth each having a concavo-convex surface and thereby deforming to bind. Therefore, the press bind unit 82 is provided with a press bind mechanism which presses and deforms a bind portion of the bunch of sheets ST to bind, and a press drive mechanism which drives the press bind mechanism to perform press binding.

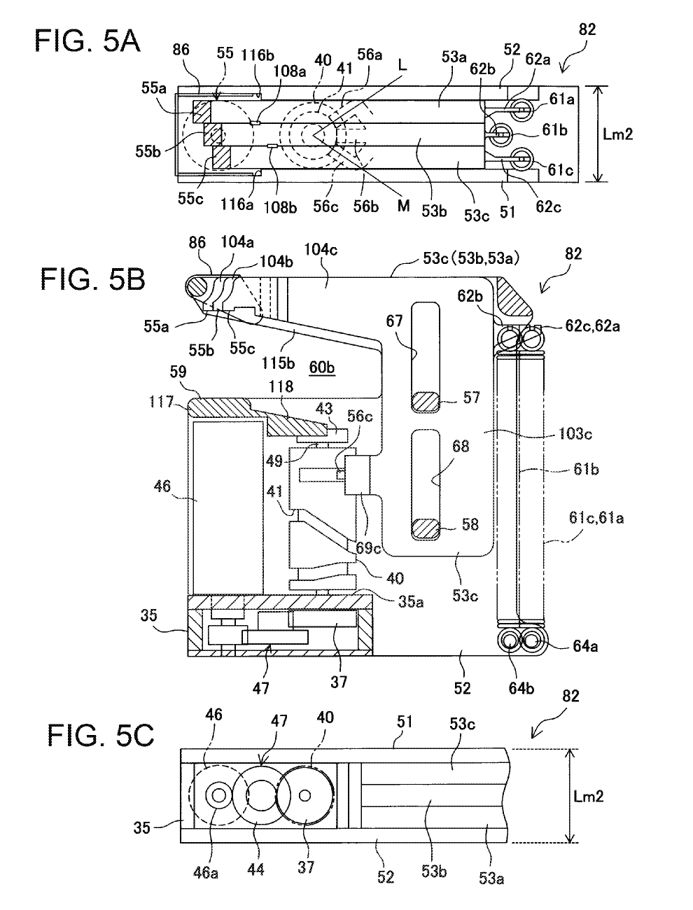

FIGS. 5A to 5C schematically illustrate the entire configuration of the press bind unit 82. The press bind mechanism of the press bind unit 82 is comprised of a front plate 51, a base plate 52, three pressing plates 53a, 53b, 53c, and press teeth comprised of pressing teeth 55a, 55b, 55c and receiving tooth 59. The press drive mechanism is comprised of a press bind motor 46, pressing springs 61a, 61b, 61c, a cam mechanism that drives the pressing plates, and a gear mechanism that connects between the press bind motor and the cam mechanism so as to enable a drive force to be transferred.

### [Press Bind Mechanism]

As shown in FIG. 5A, three pressing plates 53a to 53c each of which is a plate member are overlapped mutually in the width direction of the press bind unit 82, the front plate 51 and base plate 52 are further overlapped to sandwich the plates from the opposite sides, and the plates are mounted. The pressing plates 53a to 53c are provided to be able to slide and shift in an in-plane direction mutually and between the front plate 51 and the base plate 52, particularly, in the in-plane vertical perpendicular direction. In this Embodiment, a thickness of each of the pressing plates 53a to 53c, front plate 51 and base plate 52 is set at the order, at most, of several millimeters, and preferably about 3 mm, and it is thereby possible to make the width dimension Lm2 of the entire press bind unit 82 significantly shorter than the conventional same type of needleless bind apparatus.

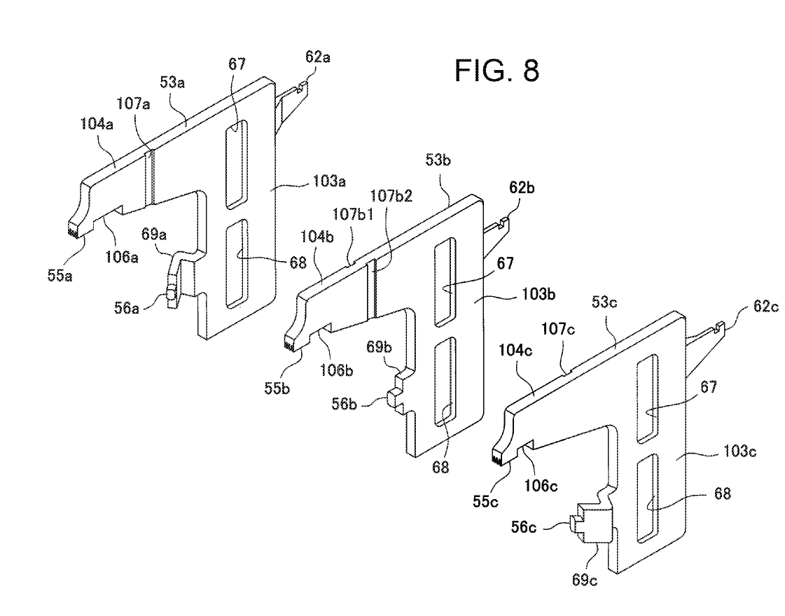

As shown in FIG. 8, each of the pressing plates 53a to 53c is formed of a relatively thin plate-shaped member forming the shape of an inverse L. Both the frontside and the backside of each of the pressing plates 53a to 53c are formed with smoothness so as to enable opposite surfaces of the other adjacent plate, front plate 51 or base plate 52 to slide. The pressing plates have movable base portions 103a to 103c each forming a substantially vertically long rectangle on the right side in the figure, and pressing arm portions 104a to 104c that extend from the upper portion of the base portion to the left side in the figure i.e. to the front side of the press bind unit 82, respectively.

In each of the movable base portions 103a to 103c, a pair of guide slots 67, 68 each extending in the vertical direction in the figure is provided to penetrate in the same line in the vertical direction. Follower pins 56a to 56c are provided at front ends of pin support portions 69a to 69c to protrude via the portions 69a to 69c, in the side on the pressing arm portion side of the movable base portions 103a to 103c, respectively. In the side on the side opposite to the pressing arm portions 104a to 104c of the movable base portions 103a to 103c, spring fastening portions 62a to 62c to fasten upper ends of the pressing springs are provided to protrude in the direction opposite to the pressing arm portions near the upper ends, respectively.

FIG. 5B illustrates a state in which upper sides of the movable base portions 103a to 103c and sides on the pressing arm portions 104a to 104c side are aligned, and the pressing plates 53a to 53c are installed in the base plate 52. As shown in FIG. 5B, in the movable base portions 103a to 103c, respective lengths in the vertical direction i.e. heights, and lengths in the right-and-left direction i.e. widths except the spring fastening portions 62a to 62c in the figure are the same. The spring fastening portions 62a, 62c of the pressing plates 53a, 53c on the front side and rear side have the same width, and in contrast thereto, the spring fastening portion 62b of the center pressing plate 53b is formed to be slightly shorter than the portions 62a, 62c. Therefore, the center spring fastening portion 62b is displaced and disposed in a dented position on the pressing arm portion side from the other spring fastening portions 62a, 62c.

Further, the guide slots 67, 68 respectively of the movable base portions 103a to 103c are formed in the same length and same certain width, and are disposed to mutually overlap completely in the installation state of FIG. 5B. Further, the cam follower pins 56a to 56c are formed in the same shape and dimension in cross section, and are disposed to be the same heights as one another in the installation state of FIG. 5B.

As shown in FIGS. 5B and 8, in the pressing arm portions 104a to 104c, pressing teeth 55a to 55c are formed integrally in lower edges of respective front end portions. Further, in the lower edges of the pressing arm portions 104a to 104c, as shown in FIG. 8, concave portions 106a to 106c with a predetermined length are formed on the movable base portion side immediately near the pressing teeth 55a to 55c, as clearances so as not to contact a portion of a bunch of sheets ST in the periphery thereof in pressing a bind portion of the bunch of sheets ST with the pressing teeth.

Further, in the pressing arm portions 104a to 104c, thin grooves 107a, 107b1, 107b2 and 107c crossing the pressing arm portions vertically in concave shapes are provided in surfaces opposed to adjacent other pressing arm portions 104a to 104c. The thin grooves 107a and 107b1, and 107b2 and 107c of opposed surfaces are mutually aligned in the longitudinal direction of the pressing arm portions, and are disposed to each define a single thin vertical through hole 108a or 108b in the installation state of FIG. 5A, respectively.

The adjacent pressing plates 53a to 53c shift relatively in a state in which opposed surfaces are in slide-contact with one another, and therefore, it is preferable that the opposed surfaces are beforehand coated with a lubricant such as, for example, grease. At this point, when the lubricant reaches the front ends of the pressing arm portions 104a to 104c through the opposed surfaces, there is the risk that the lubricant adheres to sheets to undergo binding processing and soils. The vertical through holes 108am, 108b in this Embodiment prevent the lubricant from going ahead thereof and reaching the front ends of the pressing arm portions 104a to 104c, as an oil thrower.

As shown in FIG. 5B, the pressing arm portions 104a to 104c are formed so that their lengths in the extension direction are gradually longer on the back side than on the front side in the figure, i.e. on the rear side than on the front side. By this means, as shown in FIG. 5A, the pressing teeth 55a to 55c in the front ends of the pressing arm portions are provided so that the position shifts in the extension direction, while slightly overlapping. On the other hand, other portions of the pressing arm portions 104a to 104c including the concave portions 106a to 106c are provided to overlap in the installation state of FIG. 5B.

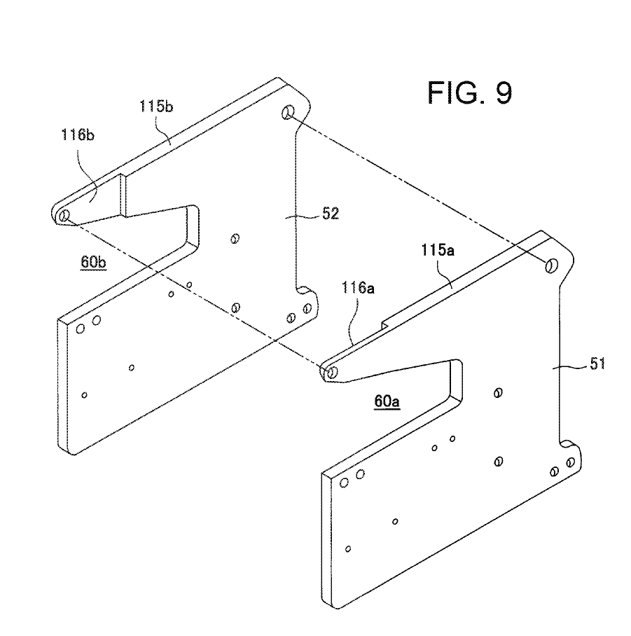

As shown in FIG. 9, the front plate 51 and base plate 52 are formed of a pair of substantially flat plate members mutually forming plane symmetry in the installation state of FIG. 5A. At the tops of the front plate 51 and base plate 52 are formed fixed arm portions 115a, 115b extending to the front side of the press bind unit 82. As shown in FIG. 5B, the fixed arm portions 115a, 115b are provided substantially in the same shape as the pressing arm portions 104a to 104c, while being slightly larger than the portions 104a to 104 so as to cover the pressing arm portions.

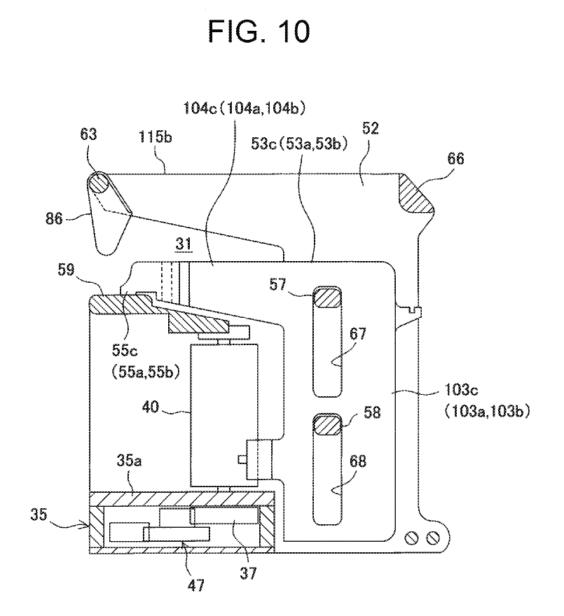

Below the fixed arm portions 115a, 115b of the front plate 51 and base plate 52 are formed notches 60a, 60b with the same shape in the form of a wedge largely opened to the front side of the press bind unit 82. The lower sides of the notches 60a, 60b are formed in the shape of a straight line approximately parallel with a sheet placement surface of the processing tray 76 when the front of the press bind unit 82 is disposed on the tray 76 side. Accordingly, by the notches 60a, 60b, as shown in FIGS. 4 and 10, a placement portion 31 is defined which is space to place a bind portion of a bunch of sheets ST to undergo press binding.

An opening height i.e. dimension in the vertical direction of the notches 60a, 60b is set to be larger than at least a thickness of the number of a bunch of sheets ST capable of undergoing needle binding with the needle binding unit 81, and is preferably set to provide sufficient allowance with respect to the thickness, in a range in which at least the bunch of sheets ST to undergo binding processing is placed or passes. A depth of the notches 60a, 60b is set at a dimension enough to place or pass a side portion of a bunch of sheets ST to undergo binding processing. For example, it is possible to set the notches 60a, 60b at substantially the same dimensions as those of the opening portion defined between the table 87 and the clincher mechanism portion 88 of the needle bind unit 81.

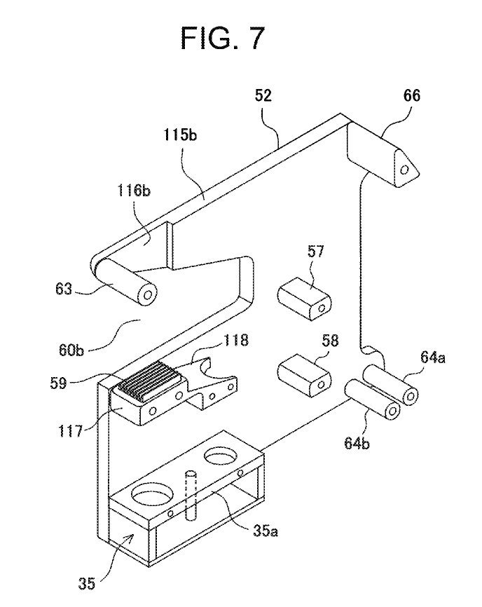

In the base plate 52, as shown in FIG. 7, in the surface opposed to the front plate 51, a joint pin 63 is provided at the front end of the fixed arm portion 115b, two joint pins 64a, 64b are provided in a position diagonally opposite thereto at the lower end on the right side in the figure, and a joint rod 66 is provided at the upper end on the right side in the figure above the pins so that each of the pins and rod protrudes in the same height. The front plate 51 is positioned in front ends of the joint pin 63, joint pins 64a, 64b and joint rod 66 and is integrally fixed with appropriate fasteners such as bolts, and a certain gap is thereby defined to install the pressing plates 53a to 53c in between the plate 51 and the base plate 52.

Further, two upper and lower guide pins 57, 58 are provided to protrude in the surface opposed to the front plate 51 of the base plate 52. The pressing plates 53a to 53c are installed in the base plate 52 in order of the rear side, center and front side, by fitting the guide slots 67, 68 into the guide pins 57, 58, respectively. The guide pins 57, 58 are provided to fit slidably only in the longitudinal direction, substantially without play in its width direction. By this means, the pressing plates 53a to 53c are held in the gap between the base plate 52 and the front plate 51 to be slidable only in the in-phase vertical direction.

Further, on the lower-side side near the opening end of the notch 60b, a fix support portion 117 of the receiving tooth 59 is integrally bonded to the base plate 52. On the top surface of the fix support portion 117, the receiving tooth 59 is integrally provided in an appropriate shape in a tooth formation region of a plane rectangle with the direction of the lower side as long sides. The receiving tooth 59 is disposed so as to face the pressing teeth 55a to 55c at the front ends of the pressing arm portions 104a to 104c disposed above.

In the fix support portion 117, a bearing support portion 118 of the cam mechanism is integrally formed so as to extend obliquely downward from the end portion on the side opposite to the opening end of the notch 60b, and is similarly integrally bonded to the base plate 52. Further, below the fix support portion 117, a press bind drive portion base 35 to attach the press drive mechanism except the pressing spring is integrally bonded along the lower side of the base plate 52.

The guide pins 57, 58, fix support portion 117, bearing support portion 118 and press bind drive portion base 35 have the same height as that of the joint pin 63, joint pins 64a, 64b and joint rod 66. In attaching to the base plate 52, the front plate 51 is integrally fixed to the guide pins 57, 58, fix support portion 117, bearing support portion 118, press bind drive portion base 35, joint pins 63, 64a, 64b and joint rod 66 with appropriate fasteners such as bolts. Thus, the entire press drive mechanism including the pressing spring as described later is stored in the gap between the front plate 51 and the base plate 52.

In the receiving tooth 59, with the direction orthogonal to the lower side being as an alignment direction of the tooth, a plurality of upward projections in the shape of ribs extending in the lower side direction, and concave grooves in the shape adapted thereto are formed alternately. The receiving tooth 59 is comprised of linear projections and concave grooves in this Embodiment, and is capable of adopting various concavo-convex shapes. Further, the alignment direction of the tooth is not limited to the direction orthogonal to the lower side direction.

As described later, the pressing teeth 55a to 55c that sequentially mesh with the receiving tooth 59 constitute the pressing tooth that corresponds to the receiving tooth 59, with three teeth continuous from the front side to the rear side as a single member. Each of the pressing teeth 55a to 55c is provided in an appropriate shape integrally in a tooth formation region of a plane rectangle smaller than the tooth formation region of the receiving tooth 59, with the extension direction of the pressing arm portion as the long side, in the lower surfaces of the front end portions of the pressing arm portions 104a to 104c.

In the pressing teeth 55a to 55c, with the thickness direction of the pressing arm portions 104a to 104c as an alignment direction of teeth respectively, a plurality of downward projections in the shape of ribs extending in the direction orthogonal to the alignment direction, and concave grooves in the shape adapted thereto are formed alternately. The downward projections and concave grooves of the pressing teeth 55a to 55c have the shape and dimensions capable of meshing with the upward projections and concave grooves of the receiving tooth 59.

In this Embodiment, in each of the pressing teeth 55a to 55c, the dimension in the alignment direction of the tooth is set at approximately ⅓ the dimension in the alignment direction of the tooth of the receiving tooth 59. When it is considered that the tooth formation region of the receiving tooth 59 is divided into three in the alignment direction of teeth, the pressing teeth 55a to 55c respectively correspond to receiving tooth portions on the front side, center and rear side. Accordingly, when the pressing plates 53a to 53c are moved down along the guide slots 67, 68 that respectively engage in the guide pins 57, 58, the pressing teeth 55a to 55c on the front side, center and rear side mesh with the receiving tooth 59 in respective corresponding receiving tooth portions.

Further, as described above, the pressing teeth 55a to 55c are disposed, while partially overlapping and shifting the position from the front side to the rear side in the extension direction of the pressing arm portions 104a to 104c. Accordingly, the pressing teeth 55a to 55c mesh with the receiving tooth 59 in a straight line in the diagonal direction for connecting a corner portion on the notch back side on the front side of the top surface of the receiving tooth 59 and a corner portion on the notch opening side on the rear side of the top surface. As a result, press traces in the shape of steps inclined in the diagonal direction are formed in a bind portion of a bunch of sheets ST subjected to press binding with the press bind unit 82.

In another Embodiment, it is possible to form press traces by the receiving tooth 59 and the pressing teeth 55a to 55c in the shape of steps inclined along another diagonal direction on the top surface of the receiving tooth 59, in a checkered pattern where the position in the long side direction on the top surface of the receiving tooth 59 is alternately changed between the front side and the rear side, or linearly in the arrangement direction of the tooth of the receiving tooth 59. For example, it is possible to form these traces by changing lengths in the extension direction of the pressing arm portions 104a to 104c, or changing the position in the extension direction of the pressing arm portion of each of the pressing teeth 55a to 55c.

Further, by arranging the pressing teeth 55a to 55c discontinuously mutually in the alignment direction of the tooth and in the extension direction of the projection, it is possible to form three discontinuous press traces between the receiving tooth 59 and the teeth 55a to 55c. For example, it is possible to form the traces, by making the dimension in the alignment direction of the tooth of the pressing teeth 55a to 55c smaller than the plate thickness of the pressing plates 53a to 53c, and/or setting positions in the extension direction of the pressing arm portions of the pressing teeth 55a to 55c not to overlap one another.

Furthermore, the tooth formation region of each of the pressing teeth 55a to 55c is not limited to the same dimension. For example, it is possible to set the pressing teeth 55a to 55c so that three plane dimensions of respective tooth formation regions mutually differ from one another, or only one of the dimensions differs from the others.

Still furthermore, the number of the pressing plates 53a to 53c is not limited to three, and may be two, or four or more. Moreover, it is also possible to provide a single pressing plate with two or more pressing teeth. In this case, it is possible to arrange a plurality of pressing teeth separately along the lower side of a single pressing plate and/or in the thickness direction of the lower side of the pressing plate.

As a matter of course, with respect to the projections and concave grooves of the receiving tooth 59 and pressing teeth 55a to 55c, it is possible to form various forms different from those in the above-mentioned Embodiments. For example, it is also possible to form the projections in the shape of slating linear ribs with respect to the alignment direction of the tooth, the shape of a V bent at some midpoint, or curved waveform.

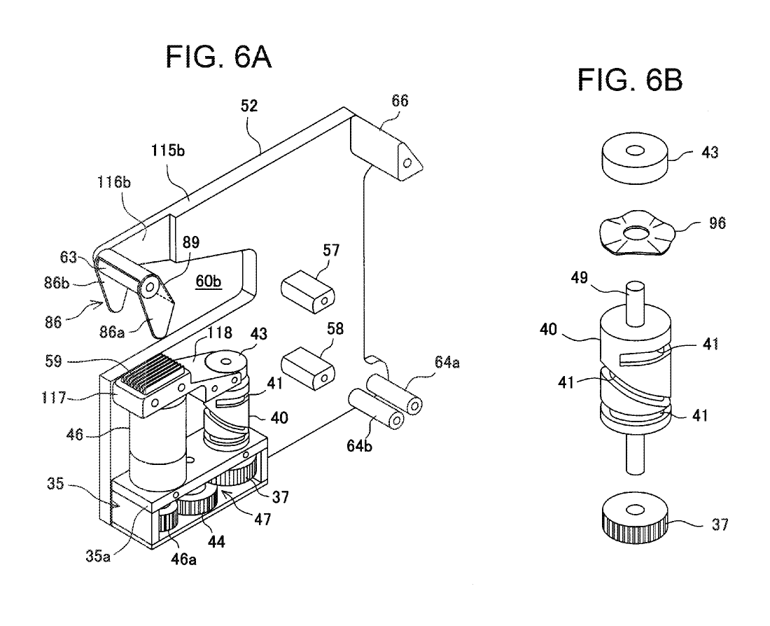

As shown in FIG. 6A, at the front end of the fixed arm portion 115b of the base plate 52, a sheet guide 86 is provided swingably by the joint pin 63. The sheet guide 86 is provided to partially limit an opening height of the notch from above so as to guide a bunch of sheets ST, which undergoes press binding with the press bind unit 82, to the placement portion 31 inside the notches 60a, 60b smoothly, without fluttering the front end portion of the bunch of sheets ST vertically.

The sheet guide 86 has a pair of guide pieces 86a, 86b with the same shape and dimensions which are disposed parallel and symmetrically at a predetermined separation distance, and an engagement plate portion 89 that joins the pieces. Each of the guide pieces 86a, 86b is made of a thin plate forming an approximately isosceles triangle where the vertex is relatively large. The engagement plate portion 89 is made of a thin plate that connects one of equilateral portions of the isosceles triangle continuously from near the vertex portion to near the base angle portion, and is formed integrally with both the guide pieces.

The sheet guide 86 is pivotally fitted into the joint pin 63 in the base angle portion on the side where the engagement plate portion 89 is provided, with the base of the isosceles triangle being on the opening side of the notch 60b. The sheet guide 86 is attached with the base of the isosceles triangle inclined obliquely downward to the back side of the notch in a state of naturally hanging from the joint pin 63 under its own weight. By this means, even when the front end portion of the sheet entering inside the notch comes into contact with the sheet guide 86, the sheet is guided downward toward the placement portion 31, without being caught or damaged.

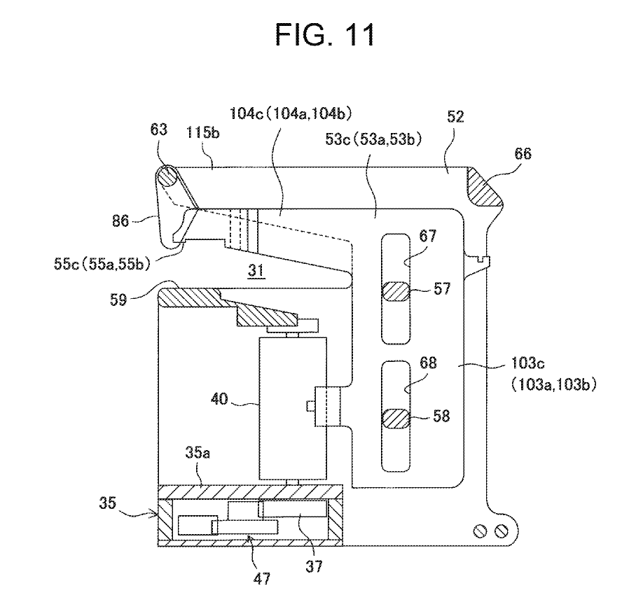

The sheet guide 86 is provided so as to vary its swing state and swing position in conjunction with vertical operation of the pressing plates 53a to 53c guided by the guide slots 67, 68 and guide pins 57, 58. FIG. 5B illustrates a state in which the pressing plates 53a to 53c wait in a top dead center position, FIG. 10 illustrates a state in which the plates perform press binding on a bunch of sheets (not shown) in a bottom dead center position, and FIG. 11 illustrates a state in which the plates wait in a sheet receiving position below the top dead center position.

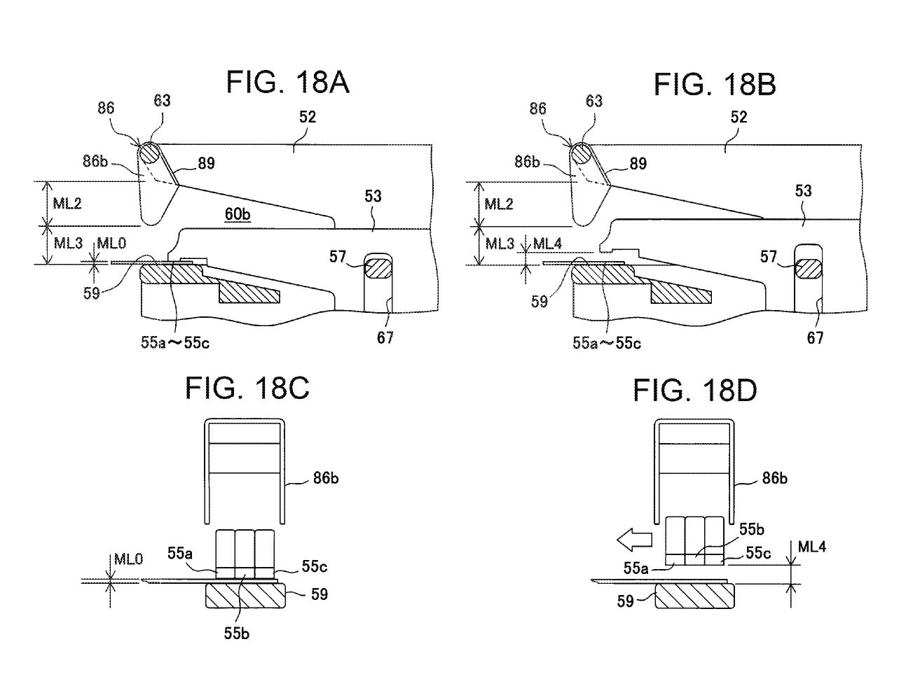

As shown in FIGS. 10 and 18A, in a press bind position where the pressing teeth 55a to 55c mesh with the receiving tooth 59 in the bottom dead center position of the pressing plates 53a to 53c, the sheet guide 86 is in the state of naturally hanging swingably, and its low end is spaced apart from the upper edge of the pressing plates 53a to 53c, and the height is positioned in approximately the same height.

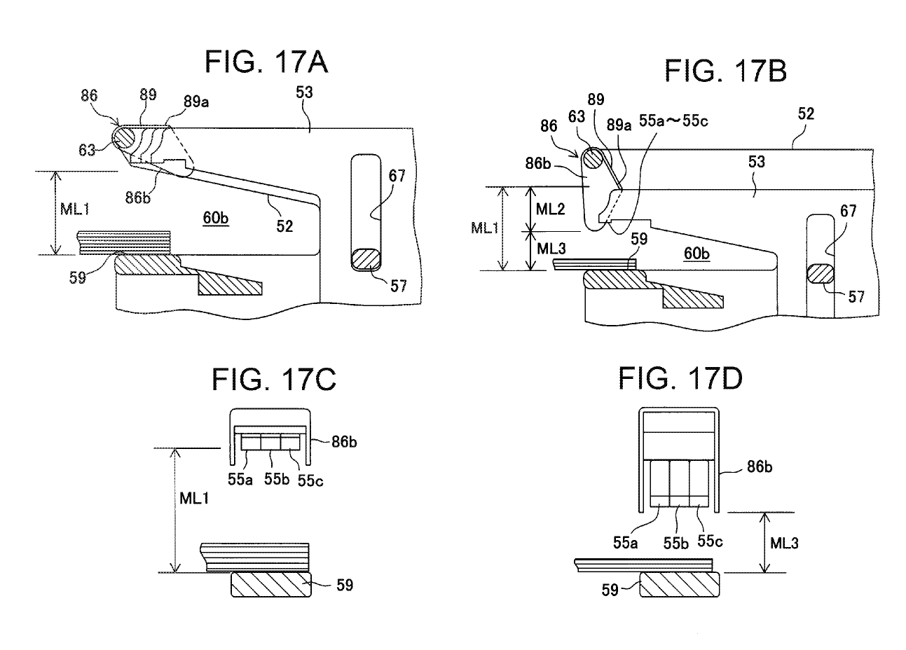

The number of sheets on which the needle bind unit 81 is capable of performing needle binding at a time is about several tens, and in contrast thereto, the number of sheets on which the press bind unit 82 is capable of performing press binding at a time is about several. Accordingly, as shown in FIGS. 17A and 17B, when it is assumed that the opening height of the notches 60a, 60b is ML1, the opening height of the notches limited by the sheet guide 86 is ML2, and that the opening height of the notches at this point is ML3, ML3 is set at a dimension that enables the number of sheets undergoing press binding to be carried in the placement portion 31 smoothly. Accordingly, ML2 is set at a size capable of reserving ML3 with respect to ML1.

As shown in FIGS. 11 and 17B, when the pressing plates 53 (53a to 53c) are in the sheet receiving position, the sheet guide 86 is in the state of naturally hanging swingably, and the pressing plates 53a to 53 are in a position of not protruding downward from the low end of the sheet guide 86 where front end portions of respective pressing arm portions 104a to 104c, particularly the pressing teeth 55a to 55c are stored in between the guide pieces 86a, 86b. Accordingly, the sheet to undergo press binding is guided smoothly to the placement portion 31, without its front end being caught in the pressing teeth 55a to 55c.

In this Embodiment, in the sheet receiving position, the pressing plates 53a to 53c are disposed so that upper edges of front end portions of the pressing arm portions 104a to 104c come into contact with a rear end 89a of the engagement plate portion 89 of the sheet guide 86. Accordingly, when the pressing plates 53a to 53b shift toward the top dead center position from this position, the sheet guide 86 rotates upward in conjunction with the ascent of the pressing plates 53a to 53c.

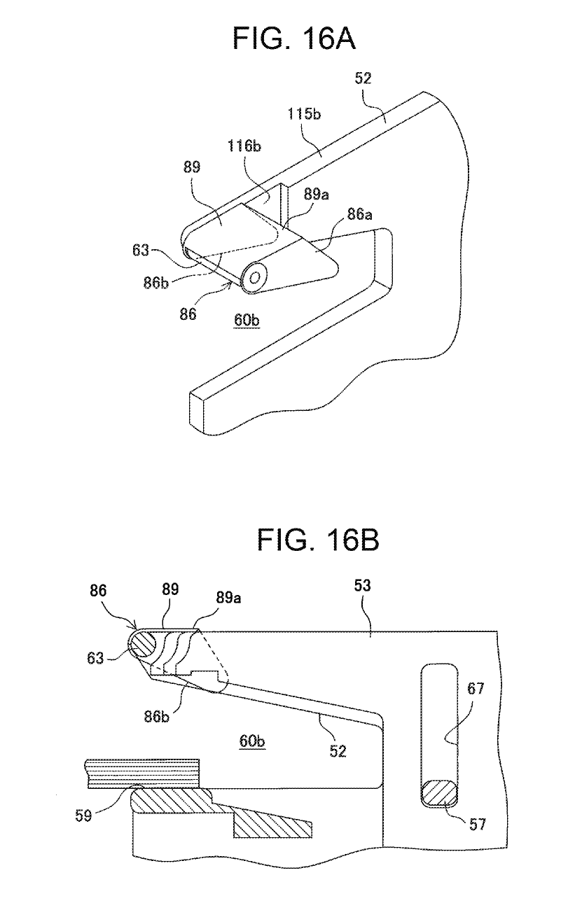

As shown in FIGS. 5A and 16A, in the front end portions of the fixed arm portions 115a, 115b, in their inner surfaces are formed shallow concave portions 116a, 116b that correspond to the guide pieces 86a, 86b of the sheet guide 86. When the pressing plates 53a to 53c arrive at the top dead center position, the guide pieces 86a, 86b of the sheet guide 86 are stored in the concave portions 116a, 116b.

As shown in FIGS. 5B, 16B and 17A, looking from the side surface, the sheet guide 86 overlaps the fixed arm portion 115b (115a) of the base plate 52 (and front plate 51) to hide, and is held not to protrude to the inside of the notches 60a, 60b from the lower side of the fixed arm portion. Accordingly, since the opening height of the notches 60a, 60b is maximum (ML1), as shown in FIG. 17A, in a state in which a bunch of sheets ST undergoing needle binding is placed in the placement portion 31, it is possible to shift the needleless bind unit 82 smoothly to the rear side or the front side on the shift bench 77 shown in FIG. 3 together with the needle bind unit 81, without the bunch of sheets ST being caught in inner peripheries of the notches 60a, 60b.

### [Press Drive Mechanism]

As shown in FIG. 5, the press bind drive portion base 35 is formed in the shape of a rectangular box with a pair of upper and lower plates and a pair of side plates. On the top surface of the upper plate 35a, the press bind motor 46 is fixed perpendicularly on the notch opening side with its output shaft protruding inside the press bind drive portion base 35. On the notch back side on the top surface of the upper plate 35a, a circular cam 40 is inserted rotatably perpendicularly parallel with the press bind motor 46.

As shown in FIG. 6B, the cylindrical cam 40 has a rotating shaft 49 integrally formed in the same axis. A bearing 43 is mounted on the upper end of the rotating shaft 49, and a spring washer 96 made of a wave washer is interposed between the bearing and the top surface of the circular cam 40. The bearing 43 is fixed to a bearing support portion 18, and supports the upper end side of the cylindrical cam 40 rotatably. The lower portion of the rotating shaft 49 is supported by the upper plate 35a rotatably, with its lower end protruding inside the press bind drive portion base 35. At this point, the lower surface of the cylindrical cam 40 directly slides on the top surface of the upper plate 35a or is supported via an appropriate bearing.

In the press bind drive portion base 35 is stored a deceleration gear line 47 comprised of a drive gear 46a installed in the front end of the output shaft of the press bind motor 46, a driven gear 37 installed in the lower end of the rotating shaft 49 of the cylindrical cam 40, and an intermediate gear 44 that meshes with the gears 46a and 37. The rotation force of the press bind motor 46 is decelerated by the deceleration gear line 47, and is transferred to the cylindrical cam 40.

A cam groove 41 is provided in a concave shape in the outer surface of the cylindrical cam 40. The cam groove 41 turns to substantially make two loops in a counterclockwise spiral shape. In the cam groove 41 are engaged the cam follower pints 56a to 56c of the pressing plates 53a to 53c successively in the rotation direction of the cylindrical cam 40. Therefore, the follower pin support portions 69a to 69c are formed so as to displace angle positions of the follower pins 56a to 56c gradually with respect to the rotating shaft 49.

In this Embodiment, the follower pin support portion 69b of the pressing plate 53b at the center extends in the same plane as the pressing plate, and the cam follower pin 56b is provided to be opposed to, at the front, the outer surface of the cylindrical cam 40 along the line M shown in FIG. 5A. In contrast thereto, in the pressing plates 53a, 53c on the front side and rear side, each of the follower pin support portions 69a, 69c is bent in the shape of a mountain for protruding outward with respect to the center follower pin support portion 69b in the out-of-plane direction. By this means, the cam follower pins 56a, 56c on the front side and rear side are provided to face the rotation center axis of the cylindrical cam 40 respectively along the lines L, M shown in FIG. 5A. By this means, it is possible to reliably engage the cam follower pins 56a to 56c in the cam groove 41.

Further, three pressing springs 61a to 61c made of tension springs each having the same tension strength are installed among the pressing plates 53a to 53c, front plate 51 and base plate 52. By this means, the pressing plates 53a to 53c are always biased downward in a direction in which the pressing teeth 55a to 55c apply pressure to the receiving tooth 59.

As shown in FIGS. 5A and 5B, in the center pressing spring 61b, its upper end is fastened to the spring fastening portion 62b at the upper end of the center pressing plate 53b, and its lower end is fastened to the joint pin 64b. In the pressing springs 61a, 61c on the front side and rear side, their upper ends are fastened to the spring fastening portions 62a, 62c at the upper ends of the pressing plates 53a, 53c on the front side and rear side, and their lower ends are fastened to the joint pin 64a, respectively. As described above, the center spring fastening portion 62b and joint pin 64b are disposed with their positions slightly displaced to the notch opening side from the other spring fastening portions 62a, 62c and joint pin 64a. By this means, without expanding a gap between the front plate 51 and the base plate 52, it is possible to arrange three pressing springs 61a to 61c in the narrow gap.

When the press bind motor 46 is rotated to rotate the cylindrical cam 40 in a clockwise direction in the figure, the pressing plates 53a to 53c are moved down in the direction of pressing sheets on the placement portion 31. At this point, the pressing plates 53a to 53c are acted upon downward by both the rotation drive force of the press bind motor 46 via the cylindrical cam 40 and the tension force of the pressing springs 61a to 61c. Thus, by configuring that a part of the pressing force of the pressing teeth 55a to 55c to the receiving tooth 59 is obtained from the pressing springs 61a to 61c, it is possible to decrease output of the press bind motor 46 itself to store in the narrow gap between the front plate 51 and the base plate 52, and to actualize miniaturization.

When the cylindrical cam 40 is rotated in a counterclockwise direction in the figure by the press bind motor 46, the pressing plates 53a to 53c are moved up in a direction of separating from the placement portion 31. At this point, the biasing force of the pressing springs 61a to 61c acts on the press bind motor 46 as resistance. Accordingly, the press bind motor 46 needs output for at least enabling the pressing plates 53a to 53c to be moved up smoothly against the biasing force of the pressing springs 61a to 61c.

### [Cylindrical Cam Operation in Press Binding]

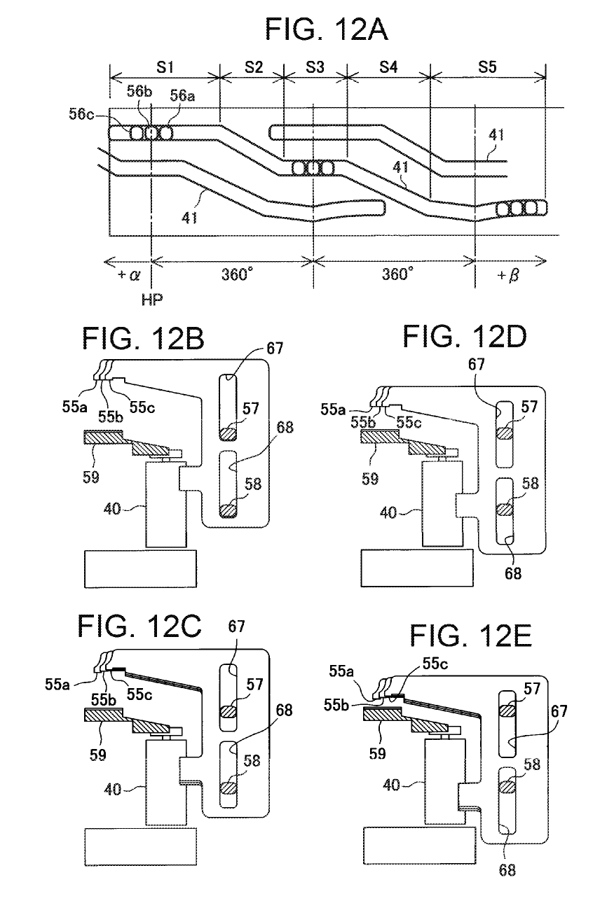

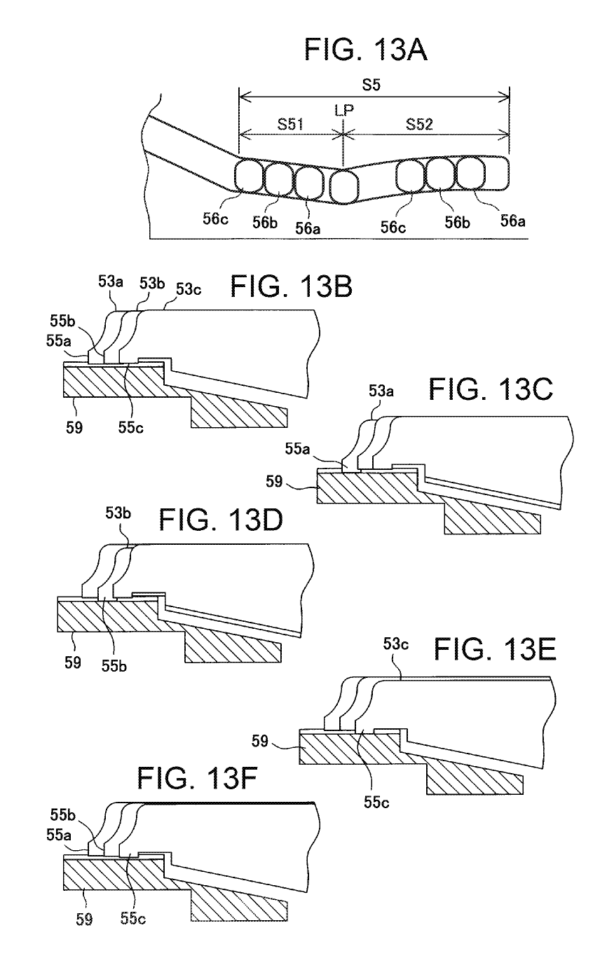

Hereinafter, referring to FIGS. 12A to 13F, press binding will be described with emphasis on operation of the cylindrical cam 40 for performing press binding. In the press bind unit 82, by the cylindrical cam 40 rotating substantially twice, the pressing plates 53a to 53c shift down approximately perpendicularly, and the pressing teeth 55a, 55b, 55c sequentially sandwich a bunch of sheets ST and press the receiving tooth 59 to crimp. Developed views of FIGS. 12A to 13F illustrate a position relationship between a track of the cam follower pins 56a to 56c that shift along the cam groove 41 for a period during which the cylindrical cam 40 rotates twice, and the receiving tooth 59 of each of the pressing teeth 55a to 55c corresponding to height positions of the pressing plates 53a to 53c at this point.

As shown in FIG. 12A, along the circumferential direction of the cylindrical cam 40, the cam groove 41 is comprised of a horizontal region S1 (that corresponds to “retract position” described later) in a highest position in the shaft line direction of the cam 40, a region S2 that is inclined substantially a certain angle downward from the region S1, a horizontal region S3 (that corresponds to “sheet receiving position” described later) in a position of rotating substantially 360° from the region S1, a region S4 (that corresponds to “intermediate position” described later”) which is inclined substantially a certain angle downward from the region S3, and a last region S5. As described later in relation to FIG. 13A, in the region S5 (that corresponds to “press position” described later), press operation is performed by the shift in the approximately perpendicular direction by the pressing teeth 55a to 55c.

First, the cam follower pins 56a to 56c wait in a home position HP in the region S1. FIG. 12B illustrates a state in which each of the pressing plates 53a to 53c is in the top dead center position. At this point, a slight gap is formed between the guide pins 57, 58 of the base plate 52 and lower ends of the guide slots 67, 68 of each of the pressing plates 53a to 53c. By this means, when the pressing plates 53a to 53c arrive at the top dead center position, the guide pins 57, 58 are prevented from colliding with the lower ends of the guide slots 67, 68 to generate a rattle, or being damaged.

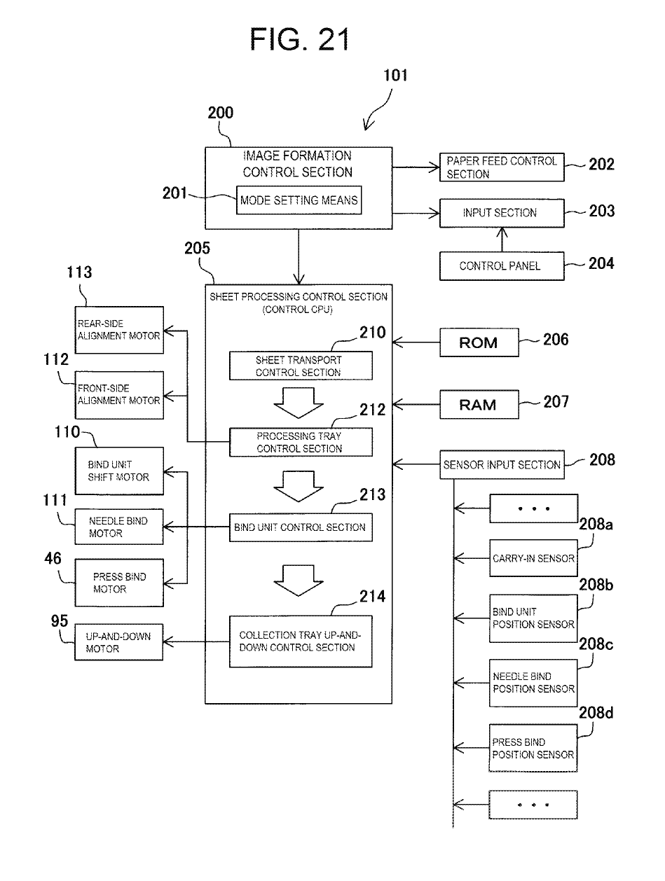

In this state, in performing press binding operation of a bunch of sheets ST sequentially fed from the image formation section 2, a bind unit control section 213 of a sheet processing control section 205 shown in FIG. 21 controls the bind unit shift motor 110, and shifts the press bind unit 82 to a press bind portion of the bunch of sheets ST. Then, the bind unit control section 213 drives the press bind motor 46 to rotate the cylindrical cam 40 in the clockwise direction in the figure. By this means, the cam follower pins 56a to 56c shift relatively along the cam groove 41, and for a period during which the pins engage in the cam groove 41 in the region S1, the height position of each of the pressing plates 53a to 53c is not changed, and is held in the state shown in FIG. 12B.

When the cam follower pins 56a to 56c shift from the region S1 to the region S2 of the cam groove 41, the positions of the cam follower pins 56a to 56c are sequentially lowered along inclination of the region S2, and in association therewith, combined with the tension force of the pressing springs 61a to 61c, each of the pressing plates 53a to 53c mutually adjoins downward to shift, while sliding. This is a state shown in FIG. 12C.

Further, when rotation of the cylindrical cam 40 proceeds and the cam makes an about one rotation from the home position HP, the cam follower pins 56a to 56c shift from the region S2 to the region S3 of the cam groove 41. Since the region S3 corresponds to the sheet receiving position of FIGS. 11 and 17B, and the cam groove is formed horizontally, as shown in FIG. 12D, the pressing plates 53a to 53c are aligned in a height position about ⅓ to ½ the distance between the receiving tooth 59 and the plates in an initial state. In this state, the press bind unit 82 waits for that the sheet is transported to the placement portion 31, and the sheet guide 86 sags downward to narrow an entrance opening of the placement portion 31, and guides a fed sheet.

When all sheets undergoing press binding are transported to the placement portion 31, second-loop rotation of the cylindrical cam 40 is started, and crimping is performed by nipping a bunch of sheets ST by the pressing teeth 55a to 55c and the receiving tooth 59. Accordingly, when press binding is indicated, the press bind unit 82 rotates the cylindrical cam 40 one loop instantaneously, waits for that sheets are transported to the placement portion 31, and when all the sheets are transported, performs crimping by rotation of second-loop rotation, and therefore, it is possible to perform press binding in a short time.

In the second-loop rotation of the cylindrical cam 40, the region where the cam follower pins 56a to 56c engage in the cam groove 41 is switched from S3 to S4. S4 is a region where the groove is inclined again, and as shown in FIG. 12E, the position of the follower pins 56a to 56c is lowered.

When the cylindrical cam 40 makes near two rotations from the home position HP, the cam follower pins 56a to 56c shift from the region S4 to the region S5 of the cam groove 41. The region S5 includes the press position of a region where the pressing teeth 55a to 55c nip a bunch of sheets ST and sequentially press the receiving tooth 59, and press binding is thereby formed.

FIGS. 13A to 13F illustrate press operation performed by the cam follower pins 56a to 56c engaging in the region S5 of the cam groove 41. As shown in FIG. 13A, the region S5 of the cam groove 41 is divided into an S51 region continued to the region S4, and an S52 region reaching a lower end portion of the cam groove 41 with the lowest point LP as a boundary. The S51 region is a groove inclined downward moderately, and as shown in FIG. 13B, as the teeth proceed toward the lowest point LP, height positions of the pressing teeth 55a, 55b, 55c are gradually lowered sequentially starting with the pressing tooth 55a to mesh with the receiving tooth 59.

Whenever the cam follower pins 56a to 56c sequentially pass through the lowest point LP of the cam groove 41 one by one, as shown in FIGS. 13C to 13E, the pressing teeth 55a to 55c are pressed to the receiving tooth 59 by strong pressure i.e. by pressing force larger than in the region S51 to be driven. As described above, since the teeth are divided into three pressing teeth, the pressing area by one pressing tooth is only ⅓ the entire pressing area. Accordingly, it is possible to crimp a bunch of sheets ST strongly by a pressing load smaller than in the case of pressing the entire pressing area at a time by a single pressing tooth.

At this point, as shown in FIGS. 10 and 18A, each of the pressing plates 53a to 53c is in the bottom dead center position, and a slight gap is formed between the guide pins 57, 58 of the base plate 52 and upper ends of the guide slots 67, 68 of each of the pressing plates 53a to 53c. By this means, when the pressing plates 53a to 53c arrive at the bottom dead center position, the guide pins 57, 58 are prevented from colliding with the upper ends of the guide slots 67, 68 to generate a rattle, or being damaged

At this point, the pressing teeth 55a to 55c are provided with the tension force of respective pressing springs 61a to 61c as the pressing force to the receiving tooth 59. As described above, since the pressing load necessary for each of the pressing teeth 55a to 55c is only low, the weak spring force is enough for each of the pressing springs 61a to 61c, and it is possible to also decrease the dimensions thereof. Accordingly, it is possible to miniaturize the entire apparatus. Further, since the guide pins 57, 58 are provided to be spaced a certain clearance away from the upper ends of the guide slots 67, 68 of each of the pressing plates 53a to 53c also after pressing, pressing is reliably performed.

When the pressing teeth 55a to 55c come into contact with the receiving tooth 59 with a bunch of sheets ST therebetween, there is the risk that the cam groove 41 and the follower pins 56a to 56c are locked by a thrust load generated in the shaft direction of the cylindrical cam 40 by a thickness of the bunch of sheets ST. In this Embodiment, as shown in FIG. 6B, the thrust load is received evenly in the circumference direction by the spring washer 96 provided between the bearing 43 and the cylindrical cam 40, and the lock between the cam groove 41 and the cam follower pins 56a to 56c is thereby prevented from occurring.

When the cam follower pins 56a to 56c pass through the lowest point LP, since the S52 region of the cam groove 41 is a groove inclined upward, meshing of the pressing teeth 55a to 55c with the receiving tooth 59 is gradually shallower starting with the pressing tooth 55a, and is in a state shown in FIG. 13F. At this point, as shown in FIG. 10, in each of the pressing plates 53a to 53c, since the guide pins 57, 58 are fitted into two guide slots 67, 68 provided vertically, respectively, the pressing plates 53a to 53c do not rotate by the tension force of the pressing springs 61a to 61c, and are moved upward reliably by rotation of the cylindrical cam 40. In addition, as shown in FIG. 10, when the pressing plates 53a to 53c release contact with the sheet guide 86, the sheet guide 86 narrows an opening on the entrance side of the placement portion 31 of a bunch of sheets ST, and is capable of also guiding introduction of a subsequent sheet.

When the cylindrical cam 40 makes about two rotations in the clockwise direction, and sequential pressing to the receiving tooth 59 by the pressing teeth 55a to 55c is finished, the bind unit control section 213 shown in FIG. 21 next rotates the press bind motor 46 backward, and performs control to return the pressing plates 53a to 53c to the home position HP. Accordingly, when the cylindrical cam 40 rotates in the counterclockwise direction in the figure, and the cam follower pins 56a to 56c shift from the region S52 to the region S51 of the cam groove 41, the pins sequentially pass through the lowest point LP again. At this point, starting with the pressing tooth 55c this time, the pressing tooth 55b and pressing tooth 55a sequentially pass through the strong pressure position in the lowest point LP, and second pressing to the receiving tooth 59 is performed by the tension force of the pressing springs 61c to 61a.

Then, the cylindrical cam 40 makes about two rotations in the counterclockwise direction, and the cam follower pins 56a to 56c follow the cam groove 41 inversely, and return to the home position HP. In association therewith, the slide guides 57, 58 of the base plate 52 shift relatively from the upper end to the lower end of long holes 67, 68 respectively, and therefore, the pressing plates 53a to 53c shift perpendicularly by the tension force of the pressing springs 61a to 61c. Accordingly, the cam mechanism by engagement of the cam groove 41 of the cylindrical cam 40 and the cam follower pins 56a to 56c controls the tension force of the pressing springs 61a to 61, and only in pressing, enables the tension force to be used in crimping a bunch of sheets ST.

### [Press Binding Operation]

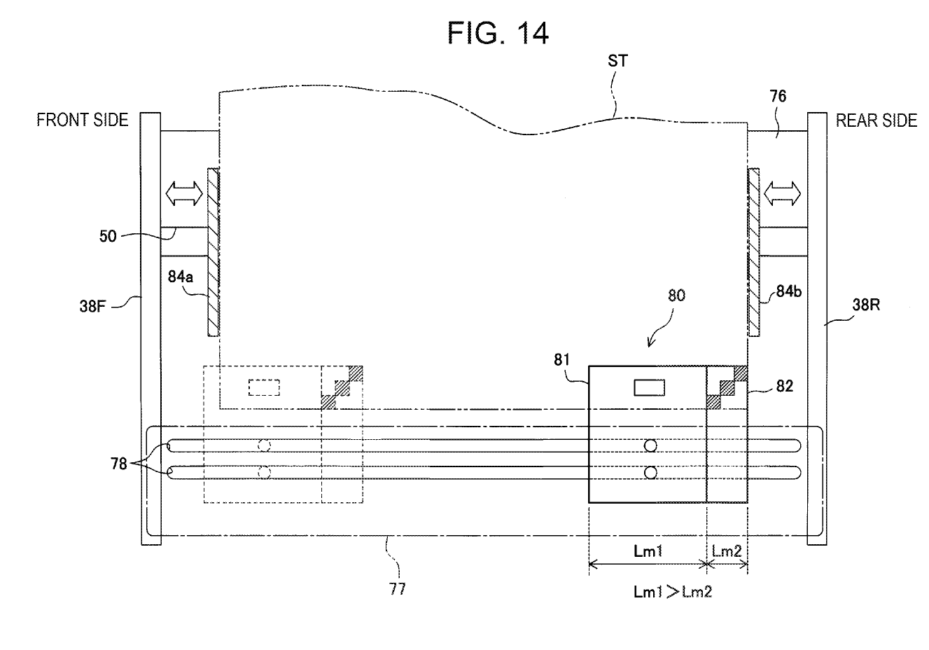

FIG. 14 illustrates a position of the sheet bind unit 80 along the shift bench 77, in the case of performing press binding on a bunch of sheets ST on the processing tray 76 with the press bind unit 82. In FIG. 14, a bunch of sheets ST is placed with its center position in the right-and-left direction aligned in the center position of the processing tray 76. At this point, the sheet bind unit 80 beforehand waits in a position slightly before a most outward position on the rear side on the processing tray 76.

In this state, a sheet is transported onto the processing tray 76, the alignment plates 84a, 84b on both left and right sides are driven to align in the center position of the processing tray 76, and this operation is repeated to form a bunch of sheets ST. At this point of time, in the bunch of sheets ST thus formed on the processing tray 76, the side portion is placed inside the placement portion 31 of the press bind unit 82 and the opening portion of the needle bind unit 81. By this means, a corner portion on the rear side of the bunch of sheets ST is positioned in the placement portion 31 of the press bind unit 82, and it is possible to press-bind the corner portion.

Further, in the press bind unit 82, in a waiting state of FIG. 14, the pressing plates 53a to 53c shift to the sheet receiving position. By this means, it is possible to shorten a vertical shift distance of the pressing plates required for press binding, and to suppress the processing time.

In another Embodiment, in the position of a bunch of sheets ST in FIG. 14, by shifting the sheet bind unit 80 to the front side, it is possible to perform press binding on a position different from the foregoing in the side portion of the bunch of sheets ST. Further, by changing the position in the right-and-left direction of the bunch of sheets ST by the alignment plates 84a, 84b, while fixing the position of the sheet bind unit 80, it is possible to similarly change a bind position of the bunch of sheets ST by press binding.

### [Needle Binding Operation]

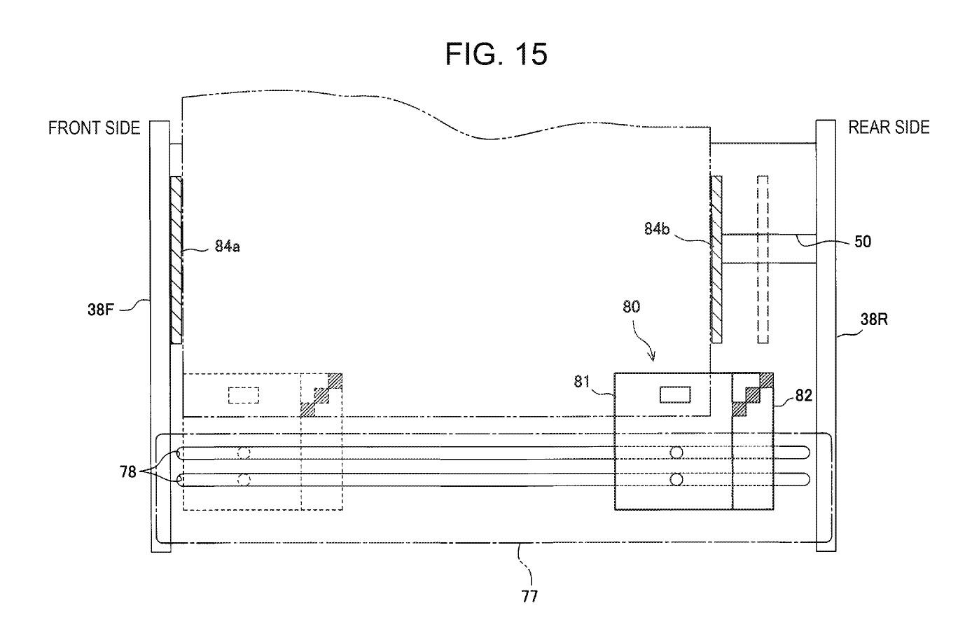

FIG. 15 illustrates a position of the sheet bind unit 80 along the shift bench 77, in the case of performing needle binding on the corner portion on the rear side of a bunch of sheets ST on the processing tray 76 with the needle bind unit 81. In FIG. 15, the sheet bind unit 80 is disposed in the most outward position on the rear side on the shift bench 77. In the needle bind unit 81 in this Embodiment, the press bind unit 82 is provided together on the rear side, and therefore, the needle bind position is shifted to the front side, as compared with the case of the needle bind unit alone.

Therefore, in this Embodiment, a bunch of sheets ST, which is collated on the processing tray 76 by the alignment plates 84a, 84b on both left and right sides, is shifted to the front side again by the alignment plates, and its corner portion on the rear side is disposed in a bind position of the needle bind unit 81 i.e. table 87. At this point, in the press bind unit 82, the pressing plates (shift portions) 53a to 53c are in the top dead center position shown in FIGS. 5B, 16B, 17A and 17C, and the sheet guide 86 is also stored in the fixed arm portions of the front plate 51 and base plate 52. Accordingly, the placement portion 31 is expanded to the maximum ML1 region in the vertical direction, and space opened between the pressing teeth 55a to 55c and the receiving tooth 59 is maximum in the vertical direction (retract position). As a result, it is possible to shift a bunch of sheets ST disposed on the table 87 of the needle bind unit 81 smoothly, without the sheets being caught in the pressing teeth 55a to 55c and/or other portion of the press bind unit 82.

Particularly, also in the case of performing needle binding in a plurality of positions of a bunch of sheets ST of which the number is high, as shown in FIGS. 5B, 16B, 17A and 17C, as in the opening portion of the needle bind unit 81, the press bind unit 82 of this Embodiment is capable of expanding the placement portion 31 largely in the vertical direction. Accordingly, a smooth shift of the needle bind unit 81 is secured.

### [Multiple Press Binding in Different Positions of a Bunch of Sheets]

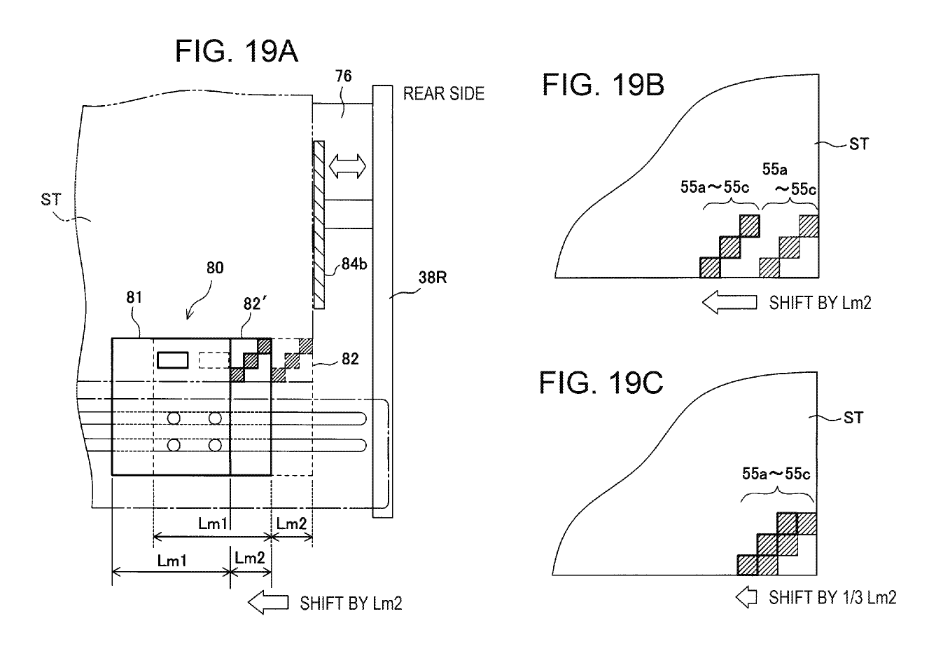

In the explanation of FIG. 13A, it is shown that the pressing teeth 55a to 55c shift and perform pressing on the receiving tooth 59 twice, by shifting from the region S52 to the region S51 of the cam groove 41 by rotation in the counterclockwise direction shown in the figure of the cylindrical cam 40. FIG. 13A illustrates that multiple press binding processing is performed in the same position of a bunch of sheets ST, and hereinafter, the case of performing multiple press binding in different positions of the same bunch of sheets ST will be described with reference to FIGS. 18A to 19C.

First, as shown in FIG. 18A, press binding is performed in a first bind position. The pressing teeth 55a to 55c at this point sequentially press the receiving tooth 59 to perform press binding. A distance between the pressing teeth 55a to 55c and the receiving tooth 59 at this point is a nearest crimping position of a distance ML0. In addition, FIG. 18C shows a front view of FIG. 18A, and the distance ML0 is also shown herein.

Herein, in the case of performing press binding processing in different positions of the same bunch of sheets ST, the pressing plates 53a to 53c are shifted in an upward direction shown in the figure, and the pressing teeth 55a to 55c integrated with the pressing plates 53a to 53c are also shifted to provide a slight gap as shown in FIG. 18B. This shift is performed by rotation of the cylindrical cam 40 described in the foregoing, and is made to a predetermined position (that corresponds to the intermediate position) of the region S4 inclined a certain angle shown in FIG. 12A.

As shown in FIGS. 18B and 18D which is a front view of FIG. 18B, the predetermined position shifts to the intermediate position (range of ML4 shown in the figure) between the receiving position (range of ML3 shown in the figure) of the pressing teeth 55a to 55c and sheet guide 86, and the press position (receiving tooth top surface ML0). The reason why the intermediate position (ML4) is set is that it takes a relatively time for the pressing teeth to shift for press binding, and that it is thereby intended to shorten the range to shift, and reduce time of the press binding processing. Further, in the intermediate position (ML4), since there is already little clearance in the bunch of sheets ST by first press binding, it is possible to set at a range significantly narrower than the initial sheet receiving position.

It is not necessary that the intermediate position is a middle position between the sheet receiving position and the press position in the shift direction of the pressing teeth 55a to 55c, and it is essential only that the intermediate position is between the sheet receiving position and the press position, and is a position where the pressing teeth 55a to 55c separate from the first press bind position. Further, the intermediate position is a position in which the pressing teeth 55a to 55c do not contact the sheet guide 86, and needless operation of the sheet guide 86 is eliminated.

After shifting the pressing teeth 55a to 55c to the intermediate position, the bind unit 80 including the press bind unit 82 is shifted to the solid-line position in FIG. 19A. In this figure, the bind unit 80 is shifted to the front side corresponding to Lm2 that is the width of the press bind unit 82. After the shift, the cylindrical cam 40 is rotated in the original direction, the pressing teeth 55a to 55c press the receiving tooth 59 again, and it is thereby possible to perform the press binding processing in the position displaced by Lm2.

FIG. 19B illustrates press traces in a state in which the pressing teeth 55a to 55c press the same bunch of sheets ST in the position displaced by Lm2. Further, FIG. 19C illustrates a state of press traces obtained by shifting the bind unit 80 to the front side in a range one-third (⅓) Lm2 and performing press binding. By thus varying the shift range of the bind unit 80 to the front side, different press traces are made in the bunch of sheets ST, and it is possible to change bind positions corresponding to the number of binding sheets and binding sheet type. Further, in the case of shifting to a different bind position inside the same bunch of sheets ST, the pressing teeth 55a to 55c shift to the intermediate position (range of ML4) nearer the receiving tooth 59 (press position) than the sheet receiving position, the shift distance of the pressing teeth 55a to 55c is shortened, and it is thereby possible to reduce multiple binding processing time.

In addition, in the above-mentioned Embodiment, the ascent of the pressing teeth 55a to 55c is once halted in the intermediate position, and then, the bind unit is shifted to the front side. Alternatively, without halting an up-and-down shift of the pressing teeth 55a to 55c, the shift of the bind unit 80 to the front side may be started when the pressing teeth 55a to 55c are in a state of separating from the receiving tooth 59, and by this means, it is possible to shorten the processing time. It is essential only that the pressing teeth 55a to 55c are shifted to a position that enables a bunch of sheets ST to be shifted to between the sheet receiving position and the press position in the width direction. Further, in the foregoing explanation, in the case of performing press binding in a different position of the same bunch of sheets ST, the press bind unit 80 is shifted, and the bunch of sheets ST may be shifted in the width direction using the alignment plates 84a, 84b and the like with the press bind unit 80 fixed.

### [Modifications of the Cam Groove of the Cylindrical Cam]

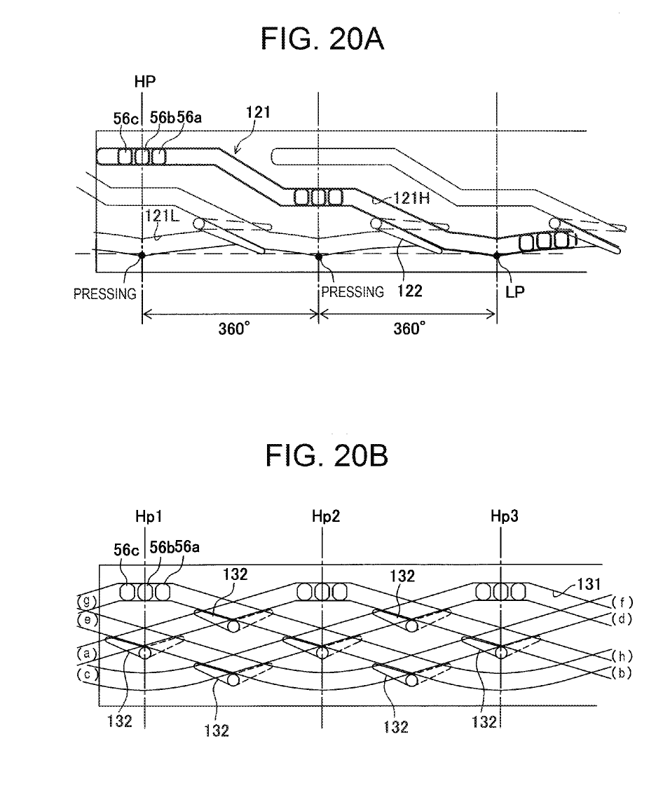

FIG. 20A illustrates a Modification of the cam groove 41 formed in the cylindrical cam 40. A cam groove 121 is the same as the cam groove 41 until arrival at the lowest position LP, and subsequent thereto, a groove portion 121L is continuously provided in the shape of snaking vertically in same height positions of the cam circumference. In this case, in a portion where the groove portion 121L snaking by rotation of the cylindrical cam 40 crosses an upper groove portion 121H reaching the groove portion 121L, a gate 122 that opens/closes in one direction is provided to enable the cam follower pins 56a, 56b, 56c to shift only in the direction along rotation of the cylindrical cam 40.

When the cylindrical cam 40 provided with such a cam groove 121 is rotated, as in the case of the cam groove 41, the cam follower pins 56a, 56b, 56c positioned in the home position HP follow the cam groove 121 and shift downward in the cylindrical cam 40. However, when the cam follower pins 56a, 56b, 56c arrive at the groove portion 121L, the pins snake along the shape of the groove portion 121L and shift in the horizontal direction. Accordingly, whenever the cam follower pins 55a, 56b, 56c pass through a valley portion of snaking, the pressing plates 55a, 55b, 55c sequentially press the receiving tooth 59 a plurality of times by the tension force of the pressing springs 61a, 61b, 61c.

Then, when the cam follower pins 55a, 56b, 56c follow the groove portion 121L and arrive at the gate 122, the pins push the gate 122 aside, and return to the beginning of the groove portion 121L again. Subsequently, for a period during which rotation of the cylindrical cam 40 is continued, the cam follower pins 55a, 56b, 56c continue to travel in the groove portion 121L, and whenever arriving at the valley portion of snaking, the pressing teeth 55a, 55b, 55c perform pressing. Accordingly, the groove portion 121L is set in the shape of pressing a bunch of sheets ST a plurality of times, by the pressing teeth 55a, 55b, 55c repeating the shift between the position separated upward from the receiving tooth 59 and the press position. By this means, the bunch of sheets ST is subjected to press binding firmly.

Next, when the cylindrical cam 40 is rotated backward, the cam follower pins 55a, 56b, 56c follow the groove portion 121L in the opposite direction, are introduced to the groove portion 121H by the gate 122 when arriving at the beginning of the groove portion 121L, follow the cam groove 121 inversely, and return to the home position HP. In addition, when the cylindrical cam 40 is rotated backward, for a period during which the cam follower pins 55a, 56b, 56c shift in the groove portion 121L of the cam groove 121, whenever the pins pass through the valley portion of snaking, the pressing plates 55a, 55b, 55c press the receiving tooth 59.

FIG. 20B illustrates an Embodiment where in the circumference surface of the cylindrical cam 40 is formed a cam groove 131 in the shape of a spiral repeated endlessly from above to below and from below to above. The cam groove 131 in this case is connected in a closed loop as shown by (a)-(b)-(c)-(d)-(e)-(f)-(g)-(h)-(a) in FIG. 20B. In the endless cam groove 131, even when the cylindrical cam 40 rotates forward and backward and causes a difference in the rotation direction, tracks traced by cam follower pins 55a, 56b, 56c are the same. Accordingly, in the cam groove 131, a gate 132 for switching between two directions corresponding to the direction along rotation is provided in each portion where the grooves cross.

According to the cam groove 131 in such a shape, even in the case where rotation of the press bind motor 46 is one direction (for example, clockwise rotation), when the cam follower pins 55a, 56b, 56c are positioned in a mountain portion in the highest position of the cylindrical cam 40, the pressing plates 53a, 53b, 53c are in the home position HP, and when the pins are positioned in a valley portion in the highest position, sequential pressing to the receiving tooth 59 by the pressing teeth 55a, 55b, 55c is performed by descent of the pressing plates 53a, 53b, 53c. In this case, when the gate 132 is closed, the cam follower pins 55a, 56b, 56c following the cam groove 131 push the gate aside to switch. Accordingly, by rotation in one direction of the press bind motor 46, the pressing teeth 55a, 55b, 55c shift between the press position and the position separated upward from the receiving tooth 59, and crimp the bunch of sheets ST repeatedly. As a matter of course, when the gate is disposed as shown by dotted lines shown in the figure, the same operation is performed also by backward rotation (i.e. counterclockwise rotation) of the press bind motor 46.

### [Control Configuration]

FIG. 21 illustrates a configuration of a control apparatus 101 of the image formation system according to this Embodiment. The control apparatus 101 is comprised of an image formation control section 200 that controls image formation operation in the image formation apparatus A, and a sheet processing control section 205 that controls post-processing operation in the sheet processing apparatus B.

The image formation control section 200 is provided with a mode setting means 201 to set an image formation made and finish mode. The finish mode includes a binding processing mode for collating and collecting sheets with images formed to perform binding processing, and a print-out mode for storing sheets in the collection tray 90 without performing binding processing, and is set at one of modes by a user of the image formation system.

In the image formation system, an input section 203 having a control panel not shown is disposed on the front side, and a user of the image formation system inputs desired finish mode, sheet size and binding mode to designate from the input section 203. When these setting are performed, the image formation control section 200 transmits the set descriptions to the sheet processing control section 205 with a finish mode instruction signal S1, sheet size signal S2, binding mode instruction signal S3 and the like.

The sheet processing control section 205 controls post-processing operation performed on fed sheets with images formed in the image formation apparatus A. The sheet processing control section 205 is comprised of a CPU, executes control programs stored in ROM 206, thereby actualizes each function of a sheet transport control section 210, processing tray control section 212, bind unit control section 213 and collection tray up-and-down control section 214, and performs post-processing operation. RAM 207 stores data required for execution of the control programs. Then, to the sheet processing control section 205 is input a detection signal from each sensor disposed in each portion of the sheet processing apparatus B via a sensor input section 208.

When a carry-in sensor 208a detects that a sheet with an image formed in the image formation apparatus A is fed from the discharge roller 14, the sheet transport control section 210 controls operation of rollers and the like of each transport system in the sheet processing apparatus B, and receives the fed sheet so as to perform predetermined post-processing corresponding to the descriptions shown by the finish mode instruction signal S1, sheet size signal S2, and binding mode instruction signal S3 output from the image formation control section 200.

The processing tray control section 212 controls rotation of alignment motors 112 and 113 respectively on the front side and rear side for shifting the alignment plates 84a, 84b to perform positioning of the sheet in the transport orthogonal direction, so as to collate and collect sheets transported from the image formation apparatus A on the processing tray 75 in executing the binding processing mode.

Based on the sheet size signal S2 and binding mode instruction signal S3, the bind unit control section 213 controls operation of needle binding or press binding corresponding to a size of fed sheets. At this point, the bind unit control section 213 controls the bind unit shift motor 110 so as to shift and halt the bind unit 81 with a bind unit position sensor 208b. In needle binding, based on a detection signal from a needle bind position sensor 208c, the section 213 controls drive of the needle bind motor 111 so as to perform needle binding on a bunch of sheets ST in a predetermined needle bind position. In press binding, based on a detection signal from a press bind position sensor 208d, the section 213 controls drive of the press bind motor 46 so as to perform press binding on a bunch of sheets ST in a predetermined press bind position.

Further, as described already, by controlling the bind unit shift motor 110, the bind unit 80 is shifted between the front side and the rear side as shown in FIG. 19A, and by driving the press bind motor 46, press traces shown in FIGS. 19B and 19C are made to enable press binding to be performed.

Based on a detection signal from a sheet height position sensor 208e, the collection tray up-and-down control section 214 controls drive of the up-and-down motor 95 so as to hold a height position of sheets collected on the collection tray 90 in a predetermined height position.

As described above, according to the sheet processing apparatus of the Embodiment, the following effects are exerted. First, as the first disclosure herein, the apparatus is provided with the placement tray (processing tray 76) to place sheets to undergo binding processing, and the press bind unit 82 capable of shifting along the end edge of sheets (bunch of sheets ST) on the placement tray, the press bind unit 82 includes the receiving tooth 59, and pressing teeth 55a to 55c which mesh with the receiving tooth to perform press binding on the sheets nipped therebetween, and the pressing teeth are provided to be able to shift between a press position (ML0) for meshing with the receiving tooth, and a retract position (ML1) spaced apart from the receiving tooth so as to shift the press bind unit 82 along the end edge of sheets with the sheets disposed between the receiving tooth and the pressing teeth.

By shifting the pressing teeth to the retract position as described above, it is possible to shift the sheet bind apparatus smoothly along the end edge of a bunch of sheets with the sheets disposed between the receiving tooth and the pressing teeth.

Next, as the second disclosure herein, it is disclosed that the press bind unit 82 is provided with a receiving portion including an opening to receive a part of a bunch of placed sheets ST, pressing teeth 55a to 55c that press from the frontside and backside of a bunch of sheets received in the receiving portion in a bind position to crimp the sheets, and the sheet guide 86 provided in the receiving portion to guide a sheet to carry in to the bind position, and that the sheet guide 86 is held to shift between the guide position (ML3) for narrowing the opening to carry the sheet in the bind position and the expanded position (ML1) with an opening wider than the opening, in conjunction with a shift in a pressing direction of the pressing teeth.

By this means, also in carrying sheets in the press bind unit for pressing a bunch of sheets to bind, the sheet guide for guiding the sheet is held to shift in conjunction with the shift of the pressing teeth, and it is thereby possible to carry the sheet in a press position stably without needing particular drive for the shift of the sheet guide and the like.

Further, as the third disclosure, it is shown that a sheet processing apparatus is comprised of the bind unit 80 that shifts along the end edge of a bunch of sheets ST placed on the placement tray (processing tray 76), the bind unit 80 is provided with a receiving portion including an opening to receive a part of a bunch of placed sheets, a bind portion that binds the bunch of sheets received in the receiving portion in a bind position, and the sheet guide 86 provided in the receiving portion to guide a bunch of sheets to carry in to the bind position, and that the sheet guide 86 is able to be positioned in the guide position (ML3) for narrowing the opening to carry in the sheets and in the expanded position (ML1) with an opening wider than the opening, and when the bind unit shifts along the end edge of a bunch of sheets, is positioned in the expanded position (ML1).

By this means, when the bind unit for shifting along the sheet edge shifts along the sheet end edge, the bind opening is expanded at the time of shifting, and it is possible to reduce the occurrence of a jam caused by catching the sheet due to the shift.

Then, as the fourth disclosure herein, a sheet processing apparatus is provided with the placement tray (processing try 76) to place sheets to undergo binding processing as a bunch, and the press bind unit 82 that is able to shift along the end edge of a bunch of sheets ST on the placement tray, and the press bind unit 82 is provided with the receiving tooth 59, and the pressing teeth 55a to 55c which mesh with the receiving tooth to perform press binding on the bunch of sheets ST nipped therebetween, where the pressing teeth include the press position (ML0) for meshing with the receiving tooth, and the sheet receiving position (ML3) spaced a predetermined distance away from the receiving tooth to receive the sheets in between the receiving tooth and the pressing teeth, and in the case of displacing the press position and performing multiple press binding on the bunch of sheets ST, are shifted to the intermediate position (ML4) between the press position and the sheet receiving position.

By this means, the separation distance between the pressing teeth and the receiving tooth is shortened in the case of performing press binding in a different position of the same bunch of sheets, and it is thereby possible to reduce the processing time of press binding in a plurality of portions.

In addition, in the description of the effects in the Embodiment in the foregoing, for each portion of this Embodiment, each component in the scope of the claims is shown in the parenthesis, or assigned the reference numeral to clarify the relationship between both the portion and the component.

The present invention is not limited to the above-mentioned Embodiments, various modifications thereof are capable of being made in the scope without departing from the invention, and all technical matters included in the technical ideas described in the scope of the claims are subjects of the invention. The Embodiments described previously illustrate preferred examples, a person skilled in the art is capable of achieving various types of alternative examples, corrected examples, modified examples or improved examples from the content disclosed in the present Description, and the examples are included in the technical scope described in the scope of the claims attached herewith.

This application claims priority from Japanese Patent Application No. 2016-118492 filed on Jun. 15, 2016 in Japan, Japanese Patent Application No. 2016-118641 filed on Jun. 15, 2016, Japanese Patent Application No. 2016-118642 filed on Jun. 15, 2016, and Japanese Patent Application No. 2016-128331 filed on Jun. 29, 2016, incorporated herein by reference.

What is claimed is:

1. A sheet processing apparatus comprising:
a placement tray adapted to place sheets to undergo binding processing; and
a press bind unit adapted to be able to shift along an end edge of sheets on the placement tray,
wherein the press bind unit includes a receiving tooth, and a pressing tooth which meshes with the receiving tooth to perform press binding on the sheets nipped therebetween, and
the pressing tooth is provided to be able to shift between a press position for meshing with the receiving tooth, and a retract position spaced apart from the receiving tooth so as to shift the press bind unit along the end edge of sheets with the sheets disposed between the receiving tooth and the pressing tooth.

2. The sheet processing apparatus according to claim 1, wherein the press bind unit is further provided with a needle bind unit for performing binding processing on a bunch of sheets with a needle, provided together in a side portion in a shift direction of the press bind unit, the needle bind unit includes an opening portion to place sheets to undergo needle binding, and a separation distance between the pressing tooth and the receiving tooth in the retract position is set to correspond to a size of the opening portion of the needle bind unit.

3. The sheet processing apparatus according to claim 1, wherein the pressing tooth is provided to be able to shift to a sheet receiving position spaced a predetermined distance away from the receiving tooth between the press position and the retract position, so as to receive sheets to undergo press binding by the press bind unit in between the receiving tooth and the pressing tooth.

4. The sheet processing apparatus according to claim 2, wherein before the needle bind unit shifts along the end edge of the sheets, the pressing tooth shifts to the retract position.

5. A sheet processing apparatus comprising:
a placement tray adapted to place transported sheets; and
a press bind unit adapted to press a bunch of sheets placed on the placement tray to bind,
wherein the press bind unit is provided with a receiving portion including an opening to receive a part of a bunch of placed sheets, pressing teeth that press from the frontside and backside of a bunch of sheets received in the receiving portion in a bind position to crimp the sheets, and
a sheet guide provided in the receiving portion to guide a sheet to carry in to the bind position, and
the apparatus is provided with a shift hold member that holds the sheet guide to shift between a guide position for narrowing the opening to carry the sheet in the bind position and an expanded position with an opening wider than the opening, in conjunction with a shift in a pressing direction of the pressing teeth.

6. The sheet processing apparatus according to claim 5, wherein the pressing teeth are able to shift to a press position for pressing a bunch of sheets to crimp, a retract position separated from the bunch of sheets, and a receiving position for receiving a sheet in the bind position between the press position and the retract position, and the sheet guide shifts to the guide position and the expanded position, corresponding to the receiving position and the retract position of the pressing teeth.

7. The sheet processing apparatus according to claim 6, wherein the sheet guide is disposed to overlap the pressing teeth, and a support member for supporting the pressing teeth is the shift hold member for holding and shifting the sheet guide.

8. The sheet processing apparatus according to claim 7, wherein when the pressing teeth shift the sheet guide to the guide position to hold, the sheet guide covers a sheet carry-in side of the pressing teeth positioned in the receiving position, and is positioned nearer the sheet than the pressing teeth.

9. The sheet processing apparatus according to claim 8, wherein when the pressing teeth shift the sheet guide to the expanded position to hold, the sheet guide is stored so as to overlap a side portion of the pressing teeth.

10. The sheet processing apparatus according to claim 9, wherein the pressing teeth shift perpendicularly to a surface of sheets to crimp, and the sheet guide is supported rotatably by the pressing teeth.

11. The sheet processing apparatus according to claim 10, wherein the press bind unit is configured to be able to shift along an end edge of sheets placed on the placement tray.

12. The sheet processing apparatus according to claim 7, wherein the sheet guide comes into contact with a rear portion on the side opposite to the pressing teeth of the support member for supporting the pressing teeth, and is shifted and held.

13. A sheet processing apparatus comprising:
a placement tray adapted to place transported sheets as a bunch; and
a bind unit adapted to shift along an end edge of a bunch of sheets placed on the placement tray,
wherein the bind unit is provided with a receiving portion including an opening to receive a part of a bunch of placed sheets, a bind portion that binds the bunch of sheets received in the receiving portion in a bind position, and
a sheet guide provided in the receiving portion to guide a bunch of sheets to carry in to the bind position, and the sheet guide is able to be positioned in a guide position for narrowing the opening to carry in a sheet and in an expanded position with an opening wider than the opening, and when the bind unit shifts along the end edge of a bunch of sheets, is positioned in the expanded position.

14. The sheet processing apparatus according to claim 13, wherein the bind unit is configured by providing together a needle bind unit for causing a needle to penetrate a bunch of sheets to perform needle binding, and a press bind unit for pressing a bunch of sheets with a pressing tooth to bind without using a needle, and the needle bind unit or the press bind unit is selected to bind a bunch of sheets.

15. The sheet processing apparatus according to claim 14, wherein the sheet guide is disposed in the receiving portion of the press bind unit.

16. The sheet processing apparatus according to claim 15, wherein in performing press binding on a bunch of sheets with the press bind unit, the bind unit is beforehand shifted to the bind position for pressing in a sheet width direction, the sheet guide is positioned in the guide position, and then, the sheet is received in the receiving portion.

17. The sheet processing apparatus according to claim 16, wherein the press bind position in the press bind unit is made in a direction in which a press trace by the pressing tooth obliquely crosses an end edge of a bunch of sheets and a side portion crossing the end edge.

18. The sheet processing apparatus according to claim 16, wherein in performing needle binding on a bunch of sheets with the needle bind unit, the sheet guide is positioned in the expanded position to carry sheets in the receiving portion, and subsequently, the bind unit is shifted to perform needle binding in the bind position in the sheet width direction.

19. The sheet processing apparatus according to claim 16, wherein in performing needle binding on a bunch of sheets with the needle bind unit, the bunch of sheets is shifted in a direction opposite to a shift of the bind unit in the sheet width direction to perform needle binding in the bind position.

20. A sheet processing apparatus comprising:
a placement tray adapted to place sheets to undergo binding processing as a bunch; and
a press bind unit adapted to be able to shift along an end edge of a bunch of sheets on the placement tray, wherein the press bind unit is provided with a receiving tooth, and a pressing tooth which meshes with the receiving tooth to perform press binding on the bunch of sheets nipped therebetween, and
the pressing tooth includes a press position for meshing with the receiving tooth, and a sheet receiving position spaced a predetermined distance away from the receiving tooth to receive the sheets in between the receiving tooth and the pressing tooth, and in the case of displacing the press position and performing multiple press binding after pressing the bunch of sheets, is shifted to an intermediate position between the press position and the sheet receiving position.

21. The sheet processing apparatus according to claim 20, wherein the pressing tooth includes a retract position separated farther from the receiving tooth than the sheet receiving position, so as to shift the press bind unit with the bunch of sheets nipped between the pressing tooth and the receiving tooth, along the end edge of the bunch of sheets, before pressing the bunch of sheets.

22. The sheet processing apparatus according to claim 20, wherein after the press binding, when the pressing tooth is shifted to the intermediate position, the press bind unit is shifted in a sheet width direction to shift the pressing tooth again to the press position.

23. The sheet processing apparatus according to claim 22, wherein the press bind unit is further provided with a needle bind unit for performing binding processing on a bunch of sheets with a needle, provided together in a side portion in a shift direction of the press bind unit, and before the needle bind unit shifts along the end edge of the sheets, the pressing tooth shifts to the retract position.

24. The sheet processing apparatus according to claim 23, wherein the press bind unit includes a sheet guide to guide the sheets to undergo binding processing to between the pressing tooth and the receiving tooth when the pressing tooth is in the sheet receiving position, and the sheet guide is in conjunction with operation of the pressing tooth for shifting between the sheet receiving position and the retract position.

25. The sheet processing apparatus according to claim 24, wherein when the pressing tooth is in the intermediate position, the sheet guide is disposed in a separate position which is not in injunction with a shift of the pressing tooth.

26. An image formation apparatus comprising:
an image formation section adapted to perform image formation on a sheet; and
the sheet processing apparatus according to claim 1 adapted to perform binding processing on sheets transported from the image formation section.
